(19) United States
(12) Patent Application Publication
(10) Pub. No.: US 2017/0046510 A1
(43) Pub. Date: Feb. 16, 2017

(54) Methods and Systems of Building Classifier Models in Computing Devices

(71) Applicant: QUALCOMM Incorporated, San Diego, CA (US)

(72) Inventors: Yin Chen, Campbell, CA (US); Vinay Sridhara, Santa Clara, CA (US); Rajarshi Gupta, Sunnyvale, CA (US)

(21) Appl. No.: 14/826,464

(22) Filed: Aug. 14, 2015

(51) Int. Cl. G06F 21/55

(52) U.S. Cl. CPC G06F 21/552; G06F 2221/033

(57) ABSTRACT

Methods, and computing devices implementing the methods, use application-based classifier models to improve the efficiency and performance of a comprehensive behavioral monitoring and analysis system predicting whether a software application is causing undesirable or performance depredating behavior. The application-based classifier models may include a reduced and more focused subset of the decision nodes that are included in a full or more complete classifier model that may be received or generated in the computing device. The application groups may be represented by application groups formed of computing device applications sharing related features, and may be generated using one or more clustering algorithms. Lean classifier models may be generated for each of the application group and may incorporate historical user input regarding execution permissions for features of applications within an application group.

### BACKGROUND

Cellular and wireless communication technologies have seen explosive growth over the past several years. This growth has been fueled by better communications, hardware, larger networks, and more reliable protocols. As a result, wireless service providers are now able to offer their customers with unprecedented levels of access to information, resources, and communications.

To keep pace with these service enhancements, mobile electronic devices (e.g., cellular phones, tablets, laptops, etc.) have become more powerful and complex than ever. This complexity has created new opportunities for malicious software, software conflicts, hardware faults, and other similar errors or phenomena to negatively impact a computing device's long-term and continued performance and power utilization levels. Accordingly, identifying and correcting the conditions and/or computing device behaviors that may negatively impact the computing device's long term and continued performance and power utilization levels is beneficial to consumers.

### SUMMARY

The methods and apparatuses of various aspects provide circuits and methods for building application-based classifier models in computing devices. Aspect methods that may be performed by a processor of a computing device may include obtaining a cluster center and a covariance matrix for generating one or more application groups, grouping applications around each cluster center to generate the one or more application groups, comparing a default classifier model to a behavior vector and associated whitelist histories for each of the applications, generating an application-based classifier model for each application group based on a result of comparing the default classifier model to the behavior vector and the associated whitelist histories for each of the applications, and using the application-based classifier model in the computing device to classify a behavior of one or more of the applications.

In some aspects, obtaining the cluster center and the covariance matrix, for generating the one or more application groups may include mapping the behavior vector of each of the applications to an N-dimensional space, determining one or more clusters of applications within the N-dimensional space using a clustering algorithm, calculating the covariance matrix for each of the clusters using the behavior vector of all the applications associated with each of the one or more clusters respectively, and calculating an average for each of the one or more clusters using the behavior vector of all the applications associated with each of the one or more clusters respectively, in which the average represents the cluster center.

In some aspects, obtaining the cluster center and the covariance matrix for generating the one or more application groups may include mapping, by a server, the behavior vector of each of the applications in a set of the applications known to be associated with one of the application groups to an N-dimensional space, calculating, by the server, the covariance matrix using the behavior vector of all of the set of the applications known to be associated with one of the application groups, where the N-dimensional space may have one or more clusters of applications, calculating, by the server, an average of the behavior vector for all of the applications, wherein the average represents the cluster center, repeating the method until the covariance matrix and the cluster center for each of the application groups is determined, transmitting, by the server, the cluster center and covariance matrix of each of the application groups, and receiving cluster centers and covariance matrices of each of the application groups in the computing device.

In some aspects, obtaining the cluster center and the covariance matrix for generating the one or more application groups may include selecting, by a server, the cluster center and covariance matrix of one or more application groups, transmitting, by the server, the cluster center and covariance matrix of the one or more application groups, and receiving the cluster center and covariance matrix of the one or more application groups in the computing device.

In some aspects, grouping the applications around each cluster center to generate the one or more application groups may include selecting the applications, determining the application groups with which each of the applications is associated, and assigning each of the applications to one or more of the application groups. In such aspects, determining the application groups with which each of the applications is associated may further include, calculating a similarity value for each of the applications with reference to each of the application groups, in which the similarity value may represent a similarity of the behavior vector of each of the applications to the cluster center of one of the application groups, determining the smallest similarity value for each of the applications, and selecting, for each of the applications, one of the application groups based on the smallest similarity value. In such aspects, the similarity value may be a mahalanobis distance.

In some aspects, comparing the default classifier model to the behavior vector and the associated whitelist histories for each of the applications may include comparing each element of the behavior vector of each of the applications to the associated whitelist histories and to a corresponding element of the default classifier model, and determining, based on the result of comparing each element of the behavior vector of each of the applications to the associated whitelist histories, whether the behavior vectors represent a different behavior classification than the behavior classification represented by the default classifier model. In such aspects, the associated whitelist histories may be records of user inputs regarding feature permissions. Alternatively, in such aspects, determining, based on the result of comparing each element of the behavior vector of each of the applications to the associated whitelist histories, whether the behavior vectors represent the different behavior classification than the behavior classification represented by the default classifier model may further include determining whether a threshold number of the behavior vectors are different from the default classifier model.

Some aspects may further include transmitting, by the computing device, the cluster center and the covariance matrix of the one or more application groups, and the application-based classifier model, receiving, by a server, the cluster center and the covariance matrix of the one or more application groups and the application-based classifier model, and storing, by the server, the cluster center and the covariance matrix of the one or more application groups and the application-based classifier model in a crowdsourcing repository.

Some aspects may further include receiving input from a user regarding whitelist permissions for a feature of the applications, and updating one of the associated whitelist histories of a behavior vector element corresponding to the feature of the applications.

Some aspects may further include generating the application groups, at regular intervals.

Aspects include a computing communication device having a processor configured with processor-executable instructions to perform operations of the aspect methods described above. Aspects include a non-transitory processor-readable medium having stored thereon processor-executable software instructions configured to cause a processor of a multi-technology communication device to perform operations of the aspect methods described above

### BRIEF DESCRIPTION OF THE DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a communication system block diagram illustrating network components of an example telecommunication system that is suitable for use with the various aspects.

FIG. 2 is a block diagram illustrating example logical components and information flows in an aspect computing device configured to determine whether a particular computing device behavior is malicious, performance-degrading, suspicious, or benign.

FIG. 3 is a block diagram illustrating example components and information flows in an aspect system that includes a network server configured to work in conjunction with a computing device to determine whether a particular computing device behavior is malicious, performance-degrading, suspicious, or benign.

FIG. 4 is a block diagram illustrating example components and information flows in an aspect system that includes a computing device configured to generate an application-based classifier models without re-training the data, behavior vectors, or classifier models.

FIG. 5A is an illustration of an example classifier model mapped to a plurality of software applications.

FIG. 5B is a process flow diagram illustrating another aspect computing device method of generating application-based classifier models locally in the computing device.

FIG. 6 is another process flow diagram illustrating another aspect computing device method of generating application-based classifier models locally in the computing device.

FIG. 7 is a process flow diagram illustrating another aspect computing device method of generating an application-based or lean classifier models in the computing device.

FIG. 8 is an illustration of example boosted decision stumps that may be generated by an aspect server processor and used by a computing device processor to generate lean classifier models.

FIG. 9 is a block diagram illustrating example logical components and information flows in an observer module configured to perform dynamic and adaptive observations in accordance with an aspect.

FIG. 10 is a block diagram illustrating logical components and information flows in a computing system implementing observer daemons in accordance with another aspect.

FIG. 11 is a process flow diagram illustrating an aspect method for performing adaptive observations on computing devices.

FIG. 12 is a process flow diagram illustrating an aspect method for building application-based classifier models.

FIG. 13 is a process flow diagram illustrating an aspect method for obtaining application-group metadata.

FIG. 14 is a process flow diagram illustrating an aspect method for generating application groups.

FIG. 15 is a process flow diagram illustrating an aspect method for analyzing whitelist history of behavior vectors.

FIG. 16 is a component block diagram of a computing device suitable for use in an aspect.

FIG. 17 is a component block diagram of a server device suitable for use in an aspect.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, the various aspects include methods, and computing devices configured to implement the methods, of using application-type or application-based classifier models (i.e., data or behavior models) to improve the efficiency and performance of a comprehensive behavioral monitoring and analysis system, and to enable the computing device to better predict whether a software application is a source or cause of an undesirable or performance depredating behavior of the computing device. The various aspects further include methods, and computing devices configured to implement the methods of determining a particular type, group or class of application for use in generating application groups and application-based classifier models (i.e., data or behavior models), as well as to select application-type specific classifier models to use in monitoring an application, and to enable the computing device to better predict whether a software application is a source or cause of an undesirable or performance depredating behavior of the computing device. An application-type or application-based classifier model may be a classifier model that identifies or includes data, information structures, and/or decision criteria that relate to evaluating a particular behavior classification, category, or type of software application (e.g., financial applications, productivity applications, etc.). For ease of reference, the term “application-based classifier models” is used herein and in the claims to refer to application-type specific classifier models and application-based classifier models as described below, which may also be application-specific models, such as when there is only one application within a given type or class.

The comprehensive behavioral monitoring and analysis system may include a network server and a computing device configured to work in conjunction with one another to intelligently and efficiently identify, classify, model, prevent, and/or correct the conditions and/or computing device behaviors that often degrade the computing device's performance and/or power utilization levels over time. The network server may be configured to receive information on various conditions, features, behaviors, and corrective actions from a central database (e.g., the “cloud”), and use this information to generate a full or robust classifier model (e.g., a data/behavior model) that describes a large corpus of information (e.g., behavior information) in a format or structure that can be quickly converted into one or more lean classifier models by a computing device. For example, the network server may generate the full classifier model to include a plurality of decision nodes (e.g., boosted decision trees, boosted decision stumps, etc.) that each evaluate or test a feature of the computing device, and which may be included in a lean classifier model.

The network server may send the full classifier to the computing device. The computing device may be configured to receive and use the full classifier model to generate a lean classifier model or a family of lean classifier models of varying levels of complexity (or “leanness”). To accomplish this, the computing device may trim, cull, or prune the decision nodes included in the full classifier model to generate lean classifier models that include a reduced number of the decision nodes and/or evaluate a limited number of test conditions.

In addition, the computing device may also dynamically generate application-type or application-based classifier models that identify and test conditions or features that are relevant to a specific type, group, or class of software application (e.g., games, navigation, financial, news, productivity, etc.). In an aspect, these application-based classifier models may be generated to include a reduced and more focused subset of the decision nodes that are included in the received full classifier model or of those included in lean classifier model generated from the received full classifier model.

In various aspects, the computing device may be configured to generate application-based classifier models for each software application in the system and/or for each type of software application in the system. The computing device may also be configured to dynamically identify the software applications and/or application types that are a high risk or susceptible to abuse (e.g., financial applications, point-of-sale applications, biometric sensor applications, etc.), and generate application-based classifier models for only the software applications and/or application types that are identified as being high risk or susceptible to abuse. In various aspects, the computing device may be configured to generate the application-based classifier models dynamically, reactively, proactively, and/or every time a new application is installed or updated.

The computing device may be configured to use the locally generated lean and/or application-based classifier models to perform real-time behavior monitoring and analysis operations. In an aspect, the computing device may be configured to use or apply multiple classifier models in parallel. In various aspects, the computing device may be configured to give preference or priority to the results generated from using or applying the application-based classifier models to a behavior/feature vector over the results generated from using/applying a more generic lean classifier model to the same or different behavior/feature vector when evaluating a specific software application. In the various aspects, the computing device may use the results of applying the classifier models to predict whether a software application, process, or complex computing device behavior is benign or contributing to the degradation of the performance or power consumption characteristics of the computing device.

By dynamically generating classifier models locally in the computing device so that they are focused or based on application-based features, the various aspects allow the computing device to focus monitoring and analysis operations on a small number of features that are most important for determining whether the operations of a specific type, group, or class of software applications are contributing to an undesirable or performance depredating behavior of the computing device. This improves the performance and power consumption characteristics of the computing device, and allows the computing device to perform the real-time behavior monitoring and analysis operations continuously or near continuously without consuming an excessive amount of computing device resources (e.g., processing, memory, or energy resources).

The word “exemplary” is used herein to mean “serving as an example, instance, or illustration.” Any implementation described herein as “exemplary” is not necessarily to be construed as preferred or advantageous over other implementations.

The term “computing device” is used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices which include a memory, and a programmable processor for which performance is important. While the various aspects are particularly useful for mobile computing devices, such as smartphones, which have limited resources and run on battery, the aspects are generally useful in any electronic device that includes a processor and executes application programs.

Generally, the performance and power efficiency of a computing device degrade over time. Recently, anti-virus companies (e.g., McAfee, Symantec, etc.) have begun marketing mobile anti-virus, firewall, and encryption products that aim to slow this degradation. However, many of these solutions rely on the periodic execution of a computationally-intensive scanning engine on the computing device, which may consume many of a mobile computing device's processing and battery resources, slow or render the mobile computing device useless for extended periods of time, and/or otherwise degrade the user experience. In addition, these solutions are typically limited to detecting known viruses and malware, and do not address the multiple complex factors and/or the interactions that often combine to contribute to a computing device's degradation over time (e.g., when the performance degradation is not caused by viruses or malware). For these and other reasons, existing anti-virus, firewall, and encryption products do not provide adequate solutions for identifying the numerous factors that may contribute to a computing device's degradation over time, for preventing computing device degradation, or for efficiently restoring an aging computing device to the computing device's original condition.

Currently, various solutions exist for modeling the behavior an application program executing on a computing device, and these solutions may be used along with machine learning techniques to determine whether a software application is malicious or benign. However, these solutions are not suitable for use on mobile computing devices because they require evaluating a very large corpus of behavior information, do not generate behavior models dynamically to account for application-type or application-based features of the computing device, do not intelligently prioritize the features in the behavior model, are limited to evaluating an individual application program or process, and/or require the execution of computationally-intensive processes in the mobile device. As such, implementing or performing these existing solutions in a mobile device may have a significant negative and/or user-perceivable impact on the responsiveness, performance, or power consumption characteristics of the mobile device.

For example, a computing device may be configured to use an existing machine learning-based solution to access and use a large corpus of training data, derive a model that takes as input a feature vector, and use this model to determine whether a software application of the computing device is malicious or benign. However, such a solution does not generate a full classifier model (i.e., a robust data or behavior model) that describes the large corpus of behavior information in a format or information structure (e.g., finite state machine, etc.) that may be used by a computing device to quickly generate a lean classifier model. For at least this reason, such a solution does not allow a computing device to generate a lean classifier model that includes decision nodes that focus on or prioritize the conditions or features that are specific to an individual application or application type. In addition, this solution does not allow a computing device to generate a lean classifier model that intelligently identifies or prioritizes the features in accordance to their relevance to classifying a specific behavior, software application, or software application type in the specific computing device in which the model is used. For these and other reasons, such a solution cannot be used by a computing device processor to quickly and efficiently identify, analyze, or classify a software application as contributing to a complex computing device behavior that has significant negative or user-perceivable impact on the responsiveness, performance, or power consumption characteristics of the computing device.

In addition to the above-mentioned limitations of existing solutions, many behavior modeling solutions implement a “one-size-fits-all” approach to modeling the behaviors of a computing device, and are therefore not suitable for use in mobile computing devices. That is, these solutions typically generate the behavior models so that they are generic and may be used in many computing devices and/or with a variety of different hardware and software configurations. As such, these generic behavior models often include/test a very large number of features, many of which are not relevant to (and thus cannot be used for) identifying, analyzing, or classifying a behavior of a specific software application or application type in the specific computing device in which they are actually used. In addition, these solutions do not assign relative priorities to features based their relevance to classifying a specific behavior in the specific computing device in which the model is used. Therefore, these solutions typically require that a computing device apply behavior models that include a large number of disorganized, improperly prioritized, or irrelevant features. Such models are not suitable for use in resource-constrained computing devices because they may cause the computing device processor to analyze a large number of features that are not useful for identifying a cause or source of the computing device's degradation over time. As such, these existing solutions are not suitable for use in complex-yet resource-constrained computing devices.

Modern computing devices are highly configurable and complex systems. As such, the features that are most important for determining whether a particular computing device behavior is benign or not benign (e.g., malicious or performance-degrading) may be different in each computing device. Further, a different combination of features may require monitoring and/or analysis in each computing device in order for that computing device to quickly and efficiently determine whether a particular behavior is benign or not benign. Yet, the precise combination of features that require monitoring and analysis, and the relative priority or importance of each feature or feature combination, can often only be determined using application group, application-type specific, and/or device-specific information obtained from the specific computing device in which the behavior is to be monitored or analyzed. For these and other reasons, behavior models generated in any computing device other than the specific device in which they are used cannot include information that identifies the precise combination of features that are most important to classifying a software application or computing device behavior in that device.

For example, if a first computing device is configured to use an associated biometric sensors (e.g., fingerprint reader, voice recognition subsystem, retina scanner, etc.) to authorize financial transactions, then features that test conditions relating to the access and use of the biometric sensors are likely to be relevant in determining whether an observed behavior of accessing financial software is malicious or benign in that computing device. For example, the access and use of the biometric sensors in the first computing device may indicate that a malicious application is authorizing financial transactions without the user's knowledge or consent. On the other hand, features that test conditions relating to the access and use of these sensors are not likely to be relevant in determining whether the observed behavior of accessing financial software is malicious or benign in a second computing device which is not configured to use an associated biometric sensor to authorize financial transactions. That is, since the first and second devices may be identical in all aspects (i.e., are the same type, model, operating system, software, etc.) except for their configuration for the use of their biometric sensors, it would be challenging to generate a generic behavior model that accurately identifies features that evaluate conditions relating to the access and use of the biometric sensors for both devices. It would be even more challenging to generate a generic model that tests much more complicated conditions or features on hundreds of thousands (or millions) of similarly equipment yet independently configurable computing devices.

In addition, computing devices are resource constrained systems that have relatively limited processing, memory, and energy resources. Modern computing devices are also complex systems having a large variety of factors that may contribute to the degradation in performance and power utilization levels of the computing device over time. Examples of factors that may contribute to performance degradation include poorly designed software applications, malware, viruses, fragmented memory, and background processes. Due to the number, variety, and complexity of these factors, it is often not feasible to evaluate all of the various components, behaviors, processes, operations, conditions, states, or features (or combinations thereof) that may degrade performance and/or power utilization levels of the complex yet resource-constrained systems of modern computing devices. As such, it is difficult for users, operating systems, or application programs (e.g., anti-virus software, etc.) to accurately and efficiently identify the sources of such problems. As a result, computing device users currently have few remedies for preventing the degradation in performance and power utilization levels of a computing device over time, or for restoring an aging computing device to the device's original performance and power utilization levels.

The various aspects include a comprehensive behavioral monitoring and analysis system for intelligently and efficiently identifying, preventing, and/or correcting the conditions, factors, and/or computing device behaviors that often degrade a computing device's performance and/or power utilization levels over time. In an aspect, an observer process, daemon, module, or sub-system (herein collectively referred to as a “module”) of the computing device may instrument or coordinate various application programming interfaces (APIs), registers, counters or other computing device components (herein collectively “instrumented components”) at various levels of the computing device system. The observer module may continuously (or near continuously) monitor computing device behaviors by collecting behavior information from the instrumented component. The computing device may also include an analyzer module, and the observer module may communicate (e.g., via a memory write operation, function call, etc.) the collected behavior information to the analyzer module. The analyzer module may receive and use the behavior information to generate feature or behavior vectors, generate spatial and/or temporal correlations based on the feature/behavior vectors, and use this information to determine whether a particular computing device behavior, condition, sub-system, software application, or process is benign, suspicious, or not benign (i.e., malicious or performance-degrading). The computing device may then use the results of this analysis to heal, cure, isolate, or otherwise fix or respond to identified problems.

The analyzer module may also be configured to perform real-time behavior analysis operations, which may include performing, executing, and/or applying data, algorithms, classifiers or models (herein collectively referred to as “classifier models”) to the collected behavior information to determine whether a software application or computing device behavior is benign or not benign (e.g., malicious or performance-degrading). Each classifier model may be a behavior model that includes data and/or information structures (e.g., feature vectors, behavior vectors, component lists, etc.) that may be used by a computing device processor to evaluate a specific feature or aspect of a computing device's behavior. Each classifier model may also include decision criteria for monitoring a number of features, factors, data points, entries, APIs, states, conditions, behaviors, applications, processes, operations, components, etc. (herein collectively “features”) in the computing device. The classifier models may be preinstalled on the computing device, downloaded or received from a network server, generated in the computing device, or any combination thereof. The classifier models may be generated by using crowd sourcing solutions, behavior modeling techniques, machine learning algorithms, etc.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes or prioritizes tests on the features/entries that are most relevant for determining whether a particular computing device behavior is benign or not benign (e.g., malicious or performance-degrading).

A locally generated lean classifier model is a lean classifier model that is generated in the computing device. An application-based classifier model may be an application specific classifier model or an application-type specific classifier model. An application specific classifier model is a classifier model that includes a focused data model that includes or prioritizes tests on the features/entries that are most relevant for determining whether a particular software application is benign or not benign (e.g., malicious or performance-degrading). An application-type specific classifier model is a classifier model that includes a focused or prioritized data model that includes or prioritizes tests on the features/entries that are most relevant for determining whether a particular type of software application is benign or not benign (e.g., malicious or performance-degrading).

As mentioned above, there may be thousands of features/factors and billions of data points that require analysis to properly identify the cause or source of a computing device's degradation. Therefore, classifier models may be trained on a very large number of features in order to support all makes and models of computing devices, and for each computing device to make accurate decisions regarding whether a particular computing device behavior is benign or not benign (e.g., malicious or performance-degrading). Yet, because computing devices are resource constrained systems, it is often not feasible for the computing device evaluate all these features. Further, computing devices come in many different configurations and varieties, and may include a large number of different software applications or application types. Yet, few computing devices (if any) include every feature or functionality that may be addressed in full classifier models. The various aspects generate lean application-based classifier models that the analyzer module may apply to evaluate a targeted subset of features that are most relevant to the software applications of a specific computing device, limiting the number of test conditions and analyses that would otherwise be performed if a generic or full classifier model was used when classifying a computing device behavior.

The various aspects include computing devices and network servers configured to work in conjunction with one another to intelligently and efficiently identify the features, factors, and data points that are most relevant to determining whether a computing device behavior is benign or not benign (e.g., malicious or performance-degrading). By generating lean classifier models locally in the computing device accounting for device-specific features and/or device-state-specific features, the various aspects allow the computing device processor to apply focused classifier models to quickly and efficiently identify, analyze, or classify a complex computing device behavior (e.g., via the observer and analyzer modules, etc.) without causing a significant negative or user-perceivable change in the responsiveness, performance, or power consumption characteristics of the computing device.

A full classifier model may be generated by a network server configured to receive a large amount of information regarding computing device behaviors and states, features, and conditions during or characterizing those behaviors from a cloud service/network. This information may be in the form of a very large cloud corpus of computing device behavior vectors. The network server may use this information to generate a full classifier model (i.e., a robust data/behavior model) that accurately describes the very large cloud corpus of behavior vectors. The network server may generate the full classifier model to include all or most of the features, data points, and/or factors that could contribute to the degradation over time of any of a number of different makes, models, and configurations of computing devices.

In an aspect, the network server may generate the full classifier model to include a finite state machine expression or representation, which may be an information structure that includes a boosted decision tree/stump or family of boosted decision trees/stumps that can be quickly and efficiently culled, modified or converted into lean classifier models that are suitable for use or execution in a computing device processor. The finite state machine expression or representation (abbreviated to “finite state machine”) may be an information structure that includes test conditions, state information, state-transition rules, and other similar information. In an aspect, the finite state machine may be an information structure that includes a large or robust family of boosted decision stumps that each evaluate or test a feature, condition, or aspect of a computing device behavior.

The computing device may be configured to receive a full classifier model from the network server, and use the received full classifier model to generate lean classifier models (i.e., data/behavior models) that are specific for the features and functionalities of the computing device.

In various aspects, the computing device may use behavior modeling and machine learning techniques to intelligently and dynamically generate the lean classifier models so that they account for device-specific and/or device-state-specific features of the computing device (e.g., features relevant to the computing device configuration, functionality, connected/included hardware, etc.), include, test or evaluate a focused and targeted subset of the features that are determined to be important for identifying a cause or source of the computing device's degradation over time, and/or prioritize the targeted subset of features based on probability or confidence values identifying their relative importance for successfully classifying a behavior in the specific computing device in which they are used/evaluated.

By generating classifier models in the computing device in which the models are used, the various aspects allow the computing device to accurately identify the specific features that are most important in determining whether a behavior on that specific computing device is benign or contributing to that device degradation in performance. These aspects also allow the computing device to accurately prioritize the features in the lean classifier models in accordance with their relative importance to classifying behaviors in that specific computing device.

The use of application-based classifier models, application-type specific classifier models, device-specific classifier models, and/or device-state-specific information may enable the computing device to quickly identify and prioritize the features that should be included in the lean classifier models, as well as to identify the features that should be excluded from the lean classifier models. For example, the computing device may be configured to identify and exclude from the lean classifier models the features/nodes/trees/stumps included in the full model that test conditions which do not pertain to a software application running on the computing device based on the application's specific feature set, and therefore are not relevant to the computing device. For example, a computing device that does not include a biometric sensor may exclude from lean classifier models all features/nodes/stumps that test or evaluate conditions relating to the use of a biometric sensor by a software application.

Further, since the lean classifier models include a reduced subset of states, features, behaviors, or conditions that must be evaluated (i.e., compared to the full classifier model), the observer and/or analyzer modules may use the lean classifier model to quickly and accurately determine whether a computing device behavior is benign or not benign (e.g., malicious or performance-degrading) without consuming an excessive amount of processing, memory, or energy resources of the computing device.

In an aspect, the computing device may be configured to use the full classifier model to generate a family of lean classifier models of varying levels of complexity (or “leanness”). The leanest family of lean classifier models (i.e., the lean classifier model based on the fewest number of test conditions) may be applied routinely until a behavior is encountered that the model cannot categorize as either benign or malicious (and therefore is categorized by the model as suspicious), at which time a more robust (i.e., less lean) lean classifier model may be applied in an attempt to categorize the behavior as either benign or malicious. The application of ever more robust lean classifier models within the family of generated lean classifier models may be applied until a definitive classification of the behavior is achieved. In this manner, the observer and/or analyzer modules can strike a balance between efficiency and accuracy by limiting the use of the most complete, but resource-intensive lean classifier models to those situations where a robust classifier model is needed to definitively classify a behavior.

In various aspects, the computing device may be configured to generate one or more lean classifier models by converting a finite state machine representation/expression into boosted decision stumps, pruning or culling the full set of boosted decision stumps based on application states specific to a particular application or a type of application, features, behaviors, conditions, or configurations to include subset or subsets of boosted decision stumps included in the full classifier model, and using the subset or subsets of boosted decision stumps to intelligently monitor, analyze and/or classify a computing device behavior.

The use of boosted decision stumps allows the observer and/or analyzer modules to generate and apply lean data models without communicating with the cloud or a network to re-train the data, which significantly reduces the computing device's dependence on the network server and the cloud. This eliminates the feedback communications between the computing device and the network server, which further improves the performance and power consumption characteristics of the computing device.

Boosted decision stumps are one level decision trees that have exactly one node (and thus one test question or test condition) and a weight value, and thus are well suited for use in a binary classification of data/behaviors. That is, applying a behavior vector to boosted decision stump results in a binary answer (e.g., Yes or No). For example, if the question/condition tested by a boosted decision stump is “is the frequency of Short Message Service (SMS) transmissions less than x per minute,” applying a value of “3” to the boosted decision stump will result in either a “yes” answer (for “less than 3” SMS transmissions) or a “no” answer (for “3 or more” SMS transmissions).

Boosted decision stumps are efficient because they are very simple and primal (and thus do not require significant processing resources). Boosted decision stumps are also very parallelizable, and thus many stumps may be applied or tested in parallel/at the same time (e.g., by multiple cores or processors in the computing device).

As described below, the network server (or another computing device) may generate a boosted decision stump-type full classifier model from another, more complex model of computing device behaviors, such as a boosted decision tree model. Such complex models may correlate the full (or nearly full) set of interactions among device states, operations, and monitored nodes that characterize computing device behavior in a sophisticated classification system. As mentioned above, the server or other computing device may generate a full, complex classifier model by applying machine learning techniques to generate models that describe a cloud corpus of behavior vectors of computing devices collected from a large number of computing devices. As an example, a boosted decision tree classifier model may trace hundreds of paths through decision nodes of testable conditions to arrive at a determination of whether a current computing device behavior is malicious or benign. Such complex models may be generated in the server using a number of known learning and correlation modeling techniques. While such complex models can become quite effective in accurately recognizing malicious behaviors by learning from data from many hundreds of computing devices, their application to a particular computing device's configuration and behaviors may require significant processing, particularly if the model involves complex, multilevel decision trees. Since computing devices are typically resource limited, using such models may impact device performance and battery life.

To render robust classifier models that are more conducive to use by computing devices, a server (e.g., a cloud server or the network server) or another computing device (e.g., a computing device or a computer that will couple to the computing device) may transform complex classifier models into large boosted decision stump models. The more simple determinations involved in decision stumps and the ability to apply such classifier models in parallel processes may enable computing devices to better benefit from the analyses performed by the network server. Also, as discussed below, a boosted decision stump full classifier model may be used by computing devices to generate a lean classifier model to include (or exclude) features based on device-specific or device-state-specific information. This may be accomplished by configuring a computing device processor to perform the aspect methods described below.

In further aspects, the computing device may include various components configured to incorporate features specific to the computing device or the computing device's current state into a lean classifier model or a set of lean classifier models used to detect malicious behavior on the computing device.

In an aspect, the computing device may be configured to generate a lean classifier model to include a subset of classifier criteria included in the full classifier model that prioritizes classifier criteria corresponding to the features relevant to the computing device configuration, functionality, and connected/included hardware. The computing device may use this lean classifier model(s) to preferentially or exclusively monitor those features and functions present or relevant to the device. The computing device may then periodically modify or regenerate the lean classifier model(s) to include or remove various features and corresponding classifier criteria based on the computing device's current state and configuration.

As an example and in an aspect, a behavior analyzer module operating on the computing device may receive a large boosted decision stumps classifier model with decision stumps associated with a full feature set of behavior models, and the behavior analyzer module may derive one or more lean classifier models from the large classifier models by selecting or prioritizing features from the large classifier model(s) that are relevant the computing device's current configuration, functionality, operating state and/or connected/included hardware, and including in the lean classifier model a subset of boosted decision stumps that correspond to the selected features. In this aspect, the classifier criteria corresponding to features relevant to the computing device may be those boosted decision stumps included in the large classifier model that test at least one of the selected features. In an aspect, the behavior analyzer module may then periodically modify or regenerate the boosted decision stumps lean classifier model(s) to include or remove various features based on the computing device's current state and configuration so that the lean classifier model continues to include device-specific feature boosted decision stumps.

In an aspect, a device state monitoring engine operating on the computing device may continually monitor the computing device for changes in the computing device's configuration and/or state. In a further aspect, the device state monitoring engine may look for configuration and/or state changes that may impact the performance or effectiveness of the behavior analyzer module (or a classifier module) to detect malicious behavior. For example, the device state monitoring engine may monitor the computing device's behaviors until a “low battery state” is detected, at which point the behavior analyzer module may change the lean classifier model to analyze fewer features on the computing device for malicious behavior in order to conserve energy.

In another aspect, the device state monitoring engine may notify a device state specific feature generator when the device state monitoring engine detects a state change, and the device state specific feature generator may signal the behavior analyzer module to add or remove certain features based on the computing device's state change.

In another aspect, the computing device may include a device specific feature generator configured to determine features related to the computing device itself For example, the device-specific feature generator may determine that the computing device includes near-field communication, Wi-Fi, and Bluetooth® capabilities. In a further aspect, the device-specific feature generator may signal the behavior analyzer to include or remove features in the lean classifier models based on the features related to the computing device itself Thus, various components on the computing device may modify a lean classifier model to reflect features specific to the computing device's configuration and/or to the computing device's current state, which may enable the various components to better detect malicious behavior or improve the overall performance of the computing device by prioritizing monitored features based on the computing device's current state.

As noted above, one example of a type of large classifier model that may be processed by a computing device to generate a lean classifier model for use in monitoring behavior is a boosted decision stumps classifier model. In the detailed descriptions that follow references may be made to boosted decision stumps classifier models; however, such references are for example purposes, and are not intended to limit the scope of the claims unless a claim explicitly recites a boosted decision stumps classifier model.

In an aspect, the computing device may be configured to generate an application-based classifier model by receiving a full classifier model that includes a plurality of test conditions from the network server, identifying the computing device features that are used by a software application of the computing device (or by a type of software application that may execute on the computing device), identifying the test conditions in the full classifier model that evaluate one of identified computing device features, determining the priority, importance or success rates of the identified test conditions, prioritizing or ordering the identified test conditions in accordance with their importance or success rates, and generating a classifier model that includes the identified test conditions so that they are ordered in accordance with their determined priorities, importance or success rates.

The computing device may be configured to use the locally generated lean and/or application-based classifier models to perform real-time behavior monitoring and analysis operations. For example, the computing device may use an application-based classifier model to classify the behavior of the computing device executing corresponding application by collecting behavior information from the computing device, using the collected behavior information to generate a feature vector, applying the generated feature vector to the application-based classifier model to evaluate each test condition included in the application-based classifier model. The computing device may also compute a weighted average of each result of evaluating test conditions in the application-based classifier model, and use the weighted average to determine whether a computing device behavior is malicious or benign.

A number of different cellular and mobile communication services and standards are available or contemplated in the future, all of which may implement and benefit from the various aspects. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iden). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

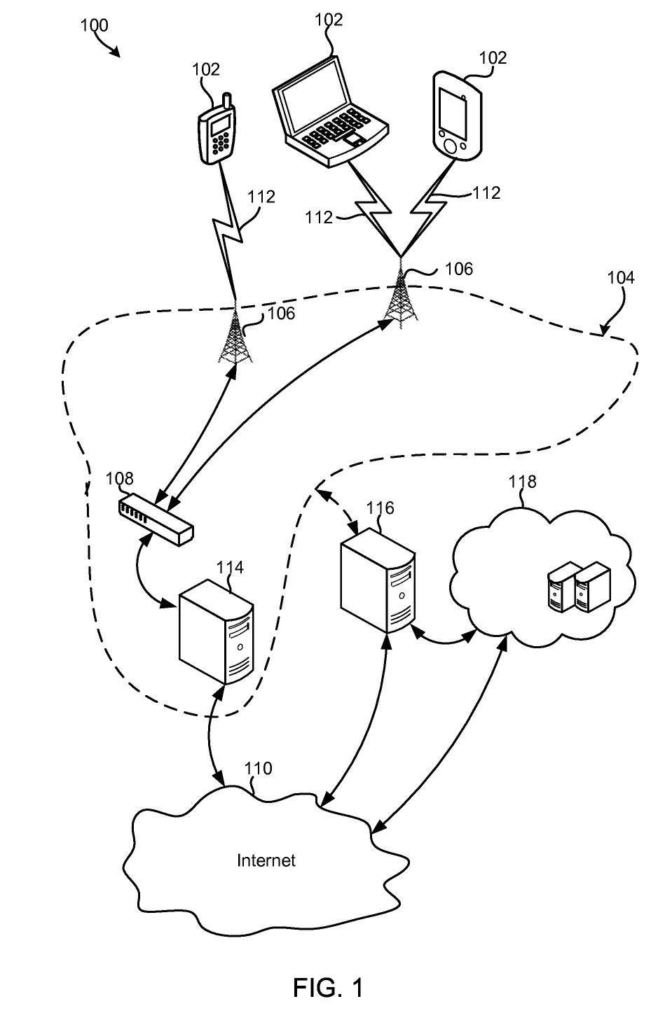

The various aspects may be implemented within a variety of communication systems, such as the example communication system 100 illustrated in FIG. 1. A typical cell telephone network 104 includes a plurality of cell base stations 106 coupled to a network operations center 108, which operates to connect voice calls and data between computing devices 102 (e.g., cell phones, laptops, tablets, etc.) and other network destinations, such as via telephone land lines (e.g., a plain old telephone system (POTS) network, not shown) and the Internet 110. Communications between the computing devices 102 and the telephone network 104 may be accomplished via two-way wireless communication links 112, such as 4G, 3G, CDMA, TDMA, LTE and/or other cell telephone communication technologies. The telephone network 104 may also include one or more servers 114 coupled to or within the network operations center 108 that provide a connection to the Internet 110.

The communication system 100 may further include network servers 116 connected to the telephone network 104 and to the Internet 110. The connection between the network servers 116 and the telephone network 104 may be through the Internet 110 or through a private network (as illustrated by the dashed arrows). A network server 116 may also be implemented as a server within the network infrastructure of a cloud service provider network 118. Communication between the network server 116 and the computing devices 102 may be achieved through the telephone network 104, the internet 110, private network (not illustrated), or any combination thereof.

The network server 116 may be configured to receive information on various conditions, features, behaviors, and corrective actions from a central database or cloud service provider network 118, and use this information to generate data, algorithms, classifiers, or behavior models (herein collectively “classifier models”) that include data and/or information structures (e.g., feature vectors, behavior vectors, component lists, etc.) that may be used by a processor of a computing device to evaluate a specific aspect of the computing device's behavior.

In an aspect, the network server 116 may be configured to generate a full classifier model. The full classifier model may be a robust data model that is generated as a function of a large training dataset, which may include thousands of features and billions of entries. In an aspect, the network server 116 may be configured to generate the full classifier model to include all or most of the features, data points, and/or factors that could contribute to the degradation of any of a number of different makes, models, and configurations of computing devices 102. In various aspects, the network server may be configured to generate the full classifier model to describe or express a large corpus of behavior information as a finite state machine, decision nodes, decision trees, or in any information structure that can be modified, culled, augmented, or otherwise used to quickly and efficiently generate leaner classifier models.

In addition, the computing device 102 may be configured to receive the full classifier model from the network server 116. The computing device may be further configured to use the full classifier model to generate more focused classifier models that account for the specific features and functionalities of the software applications of the computing device 102. For example, the computing device 102 may generate application-based classifier models (i.e., data or behavior models) that preferentially or exclusively identify or evaluate the conditions or features of the computing device that are relevant to a specific software application or to a specific type of software application (e.g., games, navigation, financial, etc.) that is installed on the computing device 102 or stored in a memory of the device. The computing device 102 may use these locally generated classifier models to perform real-time behavior monitoring and analysis operations.

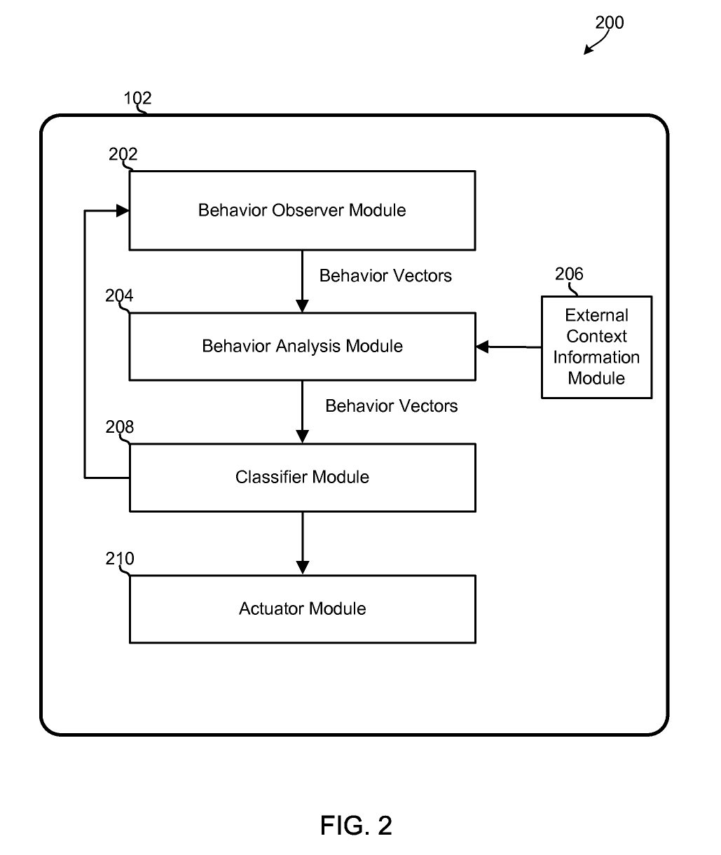

FIG. 2 illustrates example logical components and information flows in an aspect computing device 102 configured to perform real-time behavior monitoring and analysis operations 200 to determine whether a particular computing device behavior, software application, or process is malicious/performance-degrading, suspicious, or benign. These operations 200 may be performed by one or more processing cores in the computing device 102 continuously (or near continuously) without consuming an excessive amount of the computing device's processing, memory, or energy resources.

In the example illustrated in FIG. 2, the computing device 102 includes a behavior observer module 202, a behavior analyzer module 204, an external context information module 206, a classifier module 208, and an actuator module 210. In an aspect, the classifier module 208 may be implemented as part of the behavior analyzer module 204. In an aspect, the behavior analyzer module 204 may be configured to generate one or more classifier modules 208, each of which may include one or more classifier models (e.g., data/behavior models) that include data and/or information structures (e.g., decision nodes, etc.) that may be used by a computing device processor to evaluate specific features of a software application or computing device behavior.

Each of the modules 202-210 may be a thread, process, daemon, module, sub-system, or component that is implemented in software, hardware, or a combination thereof. In various aspects, the modules 202-210 may be implemented within parts of the operating system (e.g., within the kernel, in the kernel space, in the user space, etc.), within separate programs or applications, in specialized hardware buffers or processors, or any combination thereof. In an aspect, one or more of the modules 202-210 may be implemented as software instructions executing on one or more processors of the computing device 102.

The behavior observer module 202 may be configured to instrument or coordinate various APIs, registers, counters or other components (herein collectively “instrumented components”) at various levels of the computing device system, and continuously (or near continuously) monitor computing device behaviors over a period of time and in real-time by collecting behavior information from the instrumented components. For example, the behavior observer module 202 may monitor library application programming interface (API) calls, system call APIs, driver API calls, and other instrumented components by reading information from log files (e.g., API logs, etc.) stored in a memory of the computing device 102.

The behavior observer module 202 may also be configured to monitor/observe computing device operations and events (e.g., system events, state changes, etc.) via the instrumented components, collect information pertaining to the observed operations/events, intelligently filter the collected information, generate one or more observations (e.g., behavior vectors, etc.) based on the filtered information, and store the generated observations in a memory (e.g., in a log file, etc.) and/or send (e.g., via memory writes, function calls, etc.) the generated observations or collected behavior information to the behavior analyzer module 204. In various aspects, the generated observations may be stored as a behavior vector and/or in an API log file or structure.

The behavior observer module 202 may monitor/observe computing device operations and events by collecting information pertaining to library API calls in an application framework or run-time libraries, system call APIs, file-system, and networking sub-system operations, device (including sensor devices) state changes, and other similar events. The behavior observer module 202 may also monitor file system activity, which may include searching for filenames, categories of file accesses (personal info or normal data files), creating or deleting files (e.g., type exe, zip, etc.), file read/write/seek operations, changing file permissions, etc.

The behavior observer module 202 may also monitor data network activity, which may include types of connections, protocols, port numbers, server/client that the device is connected to, the number of connections, volume or frequency of communications, etc. The behavior observer module 202 may monitor phone network activity, which may include monitoring the type and number of calls or messages (e.g., SMS, etc.) sent out, received, or intercepted (e.g., the number of premium calls placed).

The behavior observer module 202 may also monitor the system resource usage, which may include monitoring the number of forks, memory access operations, number of files open, etc. The behavior observer module 202 may monitor the state of the computing device, which may include monitoring various factors, such as whether the display is on or off, whether the device is locked or unlocked, the amount of battery remaining, the state of the camera, etc. The behavior observer module 202 may also monitor inter-process communications (IPC) by, for example, monitoring intents to crucial services (browser, contracts provider, etc.), the degree of inter-process communications, pop-up windows, etc.

The behavior observer module 202 may also monitor/observe driver statistics and/or the status of one or more hardware components, which may include cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the computing device.

The behavior observer module 202 may also monitor/observe one or more hardware counters that denote the state or status of the computing device and/or computing device sub-systems. A hardware counter may include a special-purpose register of the processors/cores that is configured to store a count or state of hardware-related activities or events occurring in the computing device.

The behavior observer module 202 may also monitor/observe actions or operations of software applications, software downloads from an application download server (e.g., Apple® App Store server), computing device information used by software applications, call information, text messaging information (e.g., SendSMS, BlockSMS, ReadSMS, etc.), media messaging information (e.g., ReceiveMMS), user account information, location information, camera information, accelerometer information, browser information, content of browser-based communications, content of voice-based communications, short range radio communications (e.g., Bluetooth®, WiFi, etc.), content of text-based communications, content of recorded audio files, phonebook or contact information, contacts lists, etc.

The behavior observer module 202 may monitor/observe transmissions or communications of the computing device, including communications that include voicemail (VoiceMailComm), device identifiers (DeviceIDComm), user account information (UserAccountComm), calendar information (CalendarComm), location information (LocationComm), recorded audio information (RecordAudioComm), accelerometer information (AccelerometerComm), etc.

The behavior observer module 202 may monitor/observe usage of and updates/changes to compass information, computing device settings, battery life, gyroscope information, pressure sensors, magnet sensors, screen activity, etc. The behavior observer module 202 may monitor/observe notifications communicated to and from a software application (AppNotifications), application updates, etc. The behavior observer module 202 may monitor/observe conditions or events pertaining to a first software application requesting the downloading and/or install of a second software application. The behavior observer module 202 may monitor/observe conditions or events pertaining to user verification, such as the entry of a password, etc.

The behavior observer module 202 may also monitor/observe conditions or events at multiple levels of the computing device, including the application level, radio level, and sensor level. Application level observations may include observing the user via facial recognition software, observing social streams, observing notes entered by the user, observing events pertaining to the use of financial applications such as PassBook, Google® wallet, and Paypal, observing a software application's access and use of protected information, etc. Application level observations may also include observing events relating to the use of virtual private networks (VPNs) and events pertaining to synchronization, voice searches, voice control (e.g., lock/unlock a phone by saying one word), language translators, the offloading of data for computations, video streaming, camera usage without user activity, microphone usage without user activity, etc. The application level observation may also include monitoring a software application's use of biometric sensors (e.g., fingerprint reader, voice recognition subsystem, retina scanner, etc.) to authorize financial transactions, and conditions relating to the access and use of the biometric sensors.

Radio level observations may include determining the presence, existence or amount of any or more of: user interaction with the computing device before establishing radio communication links or transmitting information, dual/multiple subscriber identity module (SIM) cards, Internet radio, mobile phone tethering, offloading data for computations, device state communications, the use as a game controller or home controller, vehicle communications, computing device synchronization, etc. Radio level observations may also include monitoring the use of radios (WiFi, WiMax, Bluetooth, etc.) for positioning, peer-to-peer (p2p) communications, synchronization, vehicle to vehicle communications, and/or machine-to-machine (m2m). Radio level observations may further include monitoring network traffic usage, statistics, or profiles.

Sensor level observations may include monitoring a magnet sensor or other sensor to determine the usage and/or external environment of the computing device. For example, the computing device processor may be configured to determine whether the phone is in a holster (e.g., via a magnet sensor configured to sense a magnet within the holster) or in the user's pocket (e.g., via the amount of light detected by a camera or light sensor). Detecting that the computing device is in a holster may be relevant to recognizing suspicious behaviors, for example, because activities and functions related to active usage by a user (e.g., taking photographs or videos, sending messages, conducting a voice call, recording sounds, etc.) occurring while the computing device is holstered could be signs of nefarious processes executing on the device (e.g., to track or spy on the user).

Other examples of sensor level observations related to usage or external environments may include, detecting near-field communications (NFC), collecting information from a credit card scanner, barcode scanner, or mobile tag reader, detecting the presence of a universal serial bus (USB) power charging source, detecting that a keyboard or auxiliary device has been coupled to the computing device, detecting that the computing device has been coupled to a computing device (e.g., via USB, etc.), determining whether an LED, flash, flashlight, or light source has been modified or disabled (e.g., maliciously disabling an emergency signaling app, etc.), detecting that a speaker or microphone has been turned on or powered, detecting a charging or power event, detecting that the computing device is being used as a game controller, etc. Sensor level observations may also include collecting information from medical or healthcare sensors or from scanning the user's body, collecting information from an external sensor plugged into the USB/audio jack, collecting information from a tactile or haptic sensor (e.g., via a vibrator interface, etc.), collecting information pertaining to the thermal state of the computing device, collecting information from a fingerprint reader, voice recognition subsystem, retina scanner, etc.

The behavior observer module 202 may be configured to generate behavior vectors that include a concise definition of the observed behaviors. Each behavior vector may succinctly describe observed behavior of the computing device, software application, or process in a value or vector data-structure (e.g., in the form of a string of numbers, etc.). A behavior vector may also function as an identifier that enables the computing device system to quickly recognize, identify, and/or analyze computing device behaviors. In an aspect, the behavior observer module 202 may generate a behavior vector that includes a series of numbers, each of which signifies a feature or a behavior of the computing device. For example, numbers included in the behavior vector may signify whether a camera of the computing device is in use (e.g., as zero when the camera is off and one when the camera is activated), an amount of network traffic that has been transmitted from or generated by the computing device (e.g., 20 KB/sec, etc.), a number of Internet messages that have been communicated (e.g., number of SMS messages, etc.), and so forth.

There may be a large variety of factors that may contribute to the degradation in performance and power utilization levels of the computing device over time, including poorly designed software applications, malware, viruses, fragmented memory, and background processes. Due to the number, variety, and complexity of these factors, it is often not feasible to simultaneously evaluate all of the various components, behaviors, processes, operations, conditions, states, or features (or combinations thereof) that may degrade performance and/or power utilization levels of the complex yet resource-constrained systems of modern computing devices. To reduce the number of factors monitored to a manageable level, in an aspect, the behavior observer module 202 may be configured to monitor/observe an initial or reduced set of behaviors or factors that are a small subset of all factors that could contribute to the computing device's degradation.

In an aspect, the behavior observer module 202 may receive the initial set of behaviors and/or factors from a network server 116 and/or a component in a cloud service or network 118. In an aspect, the initial set of behaviors/factors may be specified in a full classifier model received from the network server 116. In another aspect, the initial set of behaviors/factors may be specified in a lean classifier model that is generated in the computing device based on the full classifier model. In an aspect, the initial set of behaviors/factors may be specified in an application-based classifier model that is generated in the computing device based on the full or lean classifier models. In various aspects, the application-based classifier model may be an application-based classifier model.

The behavior observer module 202 may communicate (e.g., via a memory write operation, function call, etc.) collected behavior information to the behavior analyzer module 204. The behavior analyzer module 204 may receive and use the behavior information to generate behavior vectors, generate spatial and/or temporal correlations based on the behavior vectors, and use this information to determine whether a particular computing device behavior, condition, sub-system, software application, or process is benign, suspicious, or not benign (i.e., malicious or performance-degrading).

The behavior analyzer module 204 and/or the classifier module 208 may be configured to perform real-time behavior analysis operations, which may include performing, executing, and/or applying data, algorithms, classifiers, or models (collectively referred to as “classifier models”) to the collected behavior information to determine whether a computing device behavior is benign or not benign (e.g., malicious or performance-degrading). Each classifier model may be a behavior model that includes data and/or information structures (e.g., feature vectors, behavior vectors, component lists, etc.) that may be used by a computing device processor to evaluate a specific feature or aspect of a computing device behavior. Each classifier model may also include decision criteria for monitoring (i.e., via the behavior observer module 202) a number of features, factors, data points, entries, APIs, states, conditions, behaviors, applications, processes, operations, components, etc. (collectively referred to as “features”) in the computing device 102. Classifier models may be preinstalled on the computing device 102, downloaded or received from the network server 116, generated in the computing device 102, or any combination thereof. The classifier models may also be generated by using crowd sourcing solutions, behavior modeling techniques, machine learning algorithms, etc.

Each classifier model may be categorized as a full classifier model or a lean classifier model. A full classifier model may be a robust data model that is generated as a function of a large training dataset, which may include thousands of features and billions of entries. A lean classifier model may be a more focused data model that is generated from a reduced dataset that includes or prioritizes tests on the features/entries that are most relevant for determining whether a particular computing device behavior is benign or not benign (e.g., malicious or performance-degrading).

The behavior analyzer module 204 and/or classifier module 208 may receive the observations or behavior information from the behavior observer module 202, compare the received information (i.e., observations) with contextual information received from the external context information module 206, and identify subsystems, processes, and/or applications associated with the received observations that are contributing to (or are likely to contribute to) the device's degradation over time, or which may otherwise cause problems on the device.

In an aspect, the behavior analyzer module 204 and/or classifier module 208 may include intelligence for utilizing a limited set of information (i.e., coarse observations) to identify behaviors, processes, or programs that are contributing to—or are likely to contribute to—the device's degradation over time, or which may otherwise cause problems on the device. For example, the behavior analyzer module 204 may be configured to analyze information (e.g., in the form of observations) collected from various modules (e.g., the behavior observer module 202, external context information module 206, etc.), learn the normal operational behaviors of the computing device, and generate one or more behavior vectors based the results of the comparisons. The behavior analyzer module 204 may send the generated behavior vectors to the classifier module 208 for further analysis.

In an aspect, the classifier module 208 may be configured to apply or compare behavior vectors to a classifier model to determine whether a particular computing device behavior, software application, or process is performance-degrading/malicious, benign, or suspicious. When the classifier module 208 determines that a behavior, software application, or process is malicious or performance-degrading, the classifier module 208 may notify the actuator module 210, which may perform various actions or operations to correct computing device behaviors determined to be malicious or performance-degrading and/or perform operations to heal, cure, isolate, or otherwise fix the identified problem.

When the classifier module 208 determines that a behavior, software application, or process is suspicious, the classifier module 208 may notify the behavior observer module 202, which may adjust the granularity of the observations (i.e., the level of detail at which computing device behaviors are observed) and/or change the behaviors that are observed based on information received from the classifier module 208 (e.g., results of the real-time analysis operations), generate or collect new or additional behavior information, and send the new/additional information to the behavior analyzer module 204 and/or classifier module 208 for further analysis/classification. Such feedback communications between the behavior observer module 202 and the classifier module 208 enable the computing device 102 to recursively increase the granularity of the observations (i.e., make finer or more detailed observations) or change the features/behaviors that are observed until a source of a suspicious or performance-degrading computing device behavior is identified, until a processing or battery consumption threshold is reached, or until the computing device processor determines that the source of the suspicious or performance-degrading computing device behavior cannot be identified from further increases in observation granularity. Such feedback communication also enable the computing device 102 to adjust or modify the data/behavior models locally in the computing device without consuming an excessive amount of the computing device's processing, memory, or energy resources.

In an aspect, the behavior observer module 202 and the behavior analyzer module 204 may provide, either individually or collectively, real-time behavior analysis of the computing system's behaviors to identify suspicious behavior from limited and coarse observations, to dynamically determine behaviors to observe in greater detail, and to dynamically determine the level of detail required for the observations. In this manner, the behavior observer module 202 enables the computing device 102 to efficiently identify and prevent problems from occurring on computing devices without requiring a large amount of processor, memory, or battery resources on the device.

In various aspects, the behavior observer module 202 and/or the behavior analyzer module 204 may be configured to analyze computing device behaviors by identifying a critical data resource that requires close monitoring, identifying an intermediate resource associated with the critical data resource, monitoring API calls made by a software application when accessing the critical data resource and the intermediate resource, identifying computing device resources that are consumed or produced by the API calls, identifying a pattern of API calls as being indicative of malicious activity by the software application, generating a light-weight behavior signature based on the identified pattern of API calls and the identified computing device resources, using the light-weight behavior signature to perform behavior analysis operations, and determining whether the software application is malicious or benign based on the behavior analysis operations.

In various aspects, the behavior observer module 202 and/or the behavior analyzer module 204 may be configured to analyze computing device behaviors by identifying APIs that are used most frequently by software applications executing on the computing device, storing information regarding usage of identified hot APIs in an API log in a memory of the computing device, and performing behavior analysis operations based on the information stored in the API log to identify computing device behaviors that are inconsistent with normal operation patterns. In an aspect, the API log may be generated so that it is organized such that the values of generic fields that remain the same across invocations of an API are stored in a separate table as the values of specific fields that are specific to each invocation of the API. The API log may also be generated so that the values of the specific fields are stored in a table along with hash keys to the separate table that stores the values of the generic fields.

In various aspects, the behavior observer module 202 and/or the behavior analyzer module 204 may be configured to analyze computing device behaviors by receiving a full classifier model that includes a finite state machine that is suitable for conversion or expression as a plurality of boosted decision stumps, generating a lean classifier model in the computing device based on the full classifier, and using the lean classifier model in the computing device to classify a behavior of the computing device as being either benign or not benign (i.e., malicious, performance degrading, etc.). In an aspect, generating the lean classifier model based on the full classifier model may include determining a number of unique test conditions that should be evaluated to classify a computing device behavior without consuming an excessive amount of processing, memory, or energy resources of the computing device, generating a list of test conditions by sequentially traversing the list of boosted decision stumps and inserting the test condition associated with each sequentially traversed boosted decision stump into the list of test conditions until the list of test conditions may include the determined number of unique test conditions, and generating the lean classifier model to include or prioritize those boosted decision stumps that test one of a plurality of test conditions included in the generated list of test conditions.

In various aspects, the behavior observer module 202 and/or the behavior analyzer module 204 may be configured to use device-specific information of the computing device to identify computing device-specific or application-based test conditions in a plurality of test conditions that are relevant to classifying a behavior of the computing device, generate a lean classifier model that includes or prioritizes the identified computing device-specific or application-based test conditions, and use the generated lean classifier model in the computing device to classify the behavior of the computing device. In an aspect, the lean classifier model may be generated to include or prioritize decision nodes that evaluate a computing device feature that is relevant to a current operating state or configuration of the computing device. In a further aspect, generating the lean classifier model may include determining a number of unique test conditions that should be evaluated to classify the behavior without consuming an excessive amount of computing device's resources (e.g., processing, memory, or energy resources), generating a list of test conditions by sequentially traversing the plurality of test conditions in the full classifier model, inserting those test conditions that are relevant to classifying the behavior of the computing device into the list of test conditions until the list of test conditions includes the determined number of unique test conditions, and generating the lean classifier model to include decision nodes included in the full classifier model that test one of the conditions included in the generated list of test conditions.

In various aspects, the behavior observer module 202 and/or the behavior analyzer module 204 may be configured to recognize computing device behaviors that are inconsistent with normal operation patterns of the computing device by monitoring an activity of a software application or process, determining an operating system execution state of the software application/process, and determining whether the activity is benign based on the activity and/or the operating system execution state of the software application or process during which the activity was monitored. In an further aspect, the behavior observer module 202 and/or the behavior analyzer module 204 may determine whether the operating system execution state of the software application or process is relevant to the activity, generate a shadow feature value that identifies the operating system execution state of the software application or process during which the activity was monitored, generate a behavior vector that associates the activity with the shadow feature value identifying the operating system execution state, and use the behavior vector to determine whether the activity is benign, suspicious, or not benign (i.e., malicious or performance-degrading).

As discussed above, a computing device processor may receive or generate a classifier model that includes a plurality of test conditions suitable for evaluating various features, identify the computing device features used by a specific software application or software application-type, identify the test conditions in the received/generated classifier model that evaluate the identified computing device features, and generate an application-based classifier models that include or prioritize the identified test conditions. The features used by the specific software application or a specific software application-type may be determined by monitoring or evaluating computing device operations, computing device events, data network activity, system resource usage, computing device state, inter-process communications, driver statistics, hardware component status, hardware counters, actions or operations of software applications, software downloads, changes to device or component settings, conditions and events at an application level, conditions and events at the radio level, conditions and events at the sensor level, location hardware, personal area network hardware, microphone hardware, speaker hardware, camera hardware, screen hardware, universal serial bus hardware, synchronization hardware, location hardware drivers, personal area network hardware drivers, near field communication hardware drivers, microphone hardware drivers, speaker hardware drivers, camera hardware drivers, gyroscope hardware drivers, browser supporting hardware drivers, battery hardware drivers, universal serial bus hardware drivers, storage hardware drivers, user interaction hardware drivers, synchronization hardware drivers, radio interface hardware drivers, and location hardware, near field communication (NFC) hardware, screen hardware, browser supporting hardware, storage hardware, accelerometer hardware, synchronization hardware, dual SIM hardware, radio interface hardware, and features unrelated related to any specific hardware.

For example, in various aspects, the computing device processor may identify computing device features used by a specific software application (or specific software application type) by collecting information from one or more instrumented components, such as an inertia sensor component, a battery hardware component, a browser supporting hardware component, a camera hardware component, a subscriber identity module (SIM) hardware component, a location hardware component, a microphone hardware component, a radio interface hardware component, a speaker hardware component, a screen hardware component, a synchronization hardware component, a storage component, a universal serial bus hardware component, a user interaction hardware component, an inertia sensor driver component, a battery hardware driver component, a browser supporting hardware driver component, a camera hardware driver component, a SIM hardware driver component, a location hardware driver component, a microphone hardware driver component, a radio interface hardware driver component, a speaker hardware driver component, a screen hardware driver component, a synchronization hardware driver component, a storage driver component, a universal serial bus hardware driver component, a hardware component connected through a universal serial bus, and a user interaction hardware driver component.

In various aspects, the computing device processor may identify computing device features used by a specific software application (or specific software application type) by monitoring or analyzing one or more of library application programming interface (API) calls in an application framework or run-time library, system call APIs, file-system and networking sub-system operations, file system activity, searches for filenames, categories of file accesses, changing of file permissions, operations relating to the creation or deletion of files, and file read/write/seek operations.

In various aspects, the computing device processor may identify computing device features used by a specific software application (or specific software application type) by monitoring or analyzing one or more of connection types, protocols, port numbers, server/client that the device is connected to, the number of connections, volume or frequency of communications, phone network activity, type and number of calls/messages sent, type and number of calls/messages received, type and number of calls/messages intercepted, call information, text messaging information, media messaging, user account information, transmissions, voicemail, and device identifiers.

In various aspects, the computing device processor may identify computing device features used by a specific software application (or specific software application type) by monitoring or analyzing one or more of the number of forks, memory access operations, and the number of files opened by the software application. In various aspects, the computing device processor may identify computing device features used by a specific software application (or specific software application type) by monitoring or analyzing state changes caused by the software application, including a display on/off state, locked/unlocked state, battery charge state, camera state, and microphone state.

In various aspects, the computing device processor may identify computing device features used by a specific software application (or specific software application type) by monitoring or analyzing crucial services, a degree of inter-process communications, and pop-up windows generated by the software application. In various aspects, the computing device processor may identify computing device features used by a specific software application (or specific software application type) by monitoring or analyzing statistics from drivers for one or more of cameras, sensors, electronic displays, WiFi communication components, data controllers, memory controllers, system controllers, access ports, peripheral devices, wireless communication components, and external memory chips.

In various aspects, the computing device processor may identify computing device features used by a specific software application (or specific software application type) by monitoring or analyzing the access or use of cameras, sensors, electronic displays, WiFi communication components, data controllers, memory controllers, system controllers, access ports, timers, peripheral devices, wireless communication components, external memory chips, voltage regulators, oscillators, phase-locked loops, peripheral bridges, and other similar components used to support the processors and clients running on the computing device.

In various aspects, the computing device processor may identify computing device features used by a specific software application (or specific software application type) by monitoring or analyzing the access or use of hardware counters that denote the state or status of the computing device and/or computing device sub-systems and/or special-purpose registers of processors/cores that are configured to store a count or state of hardware-related activities or events.

In various aspects, the computing device processor may identify computing device features used by a specific software application (or specific software application type) by monitoring or analyzing the types of information used by the software application, including location information, camera information, accelerometer information, browser information, content of browser-based communications, content of voice-based communications, short range radio communications, content of text-based communications, content of recorded audio files, phonebook or contact information, contacts lists, calendar information, location information, recorded audio information, accelerometer information, notifications communicated to and from a software application, user verifications, and a user password.

In various aspects, the computing device processor may identify computing device features used by a specific software application (or specific software application type) by monitoring or analyzing one or more of software downloads from an application download server, and a first software application requesting the downloading and/or install of a second software application.

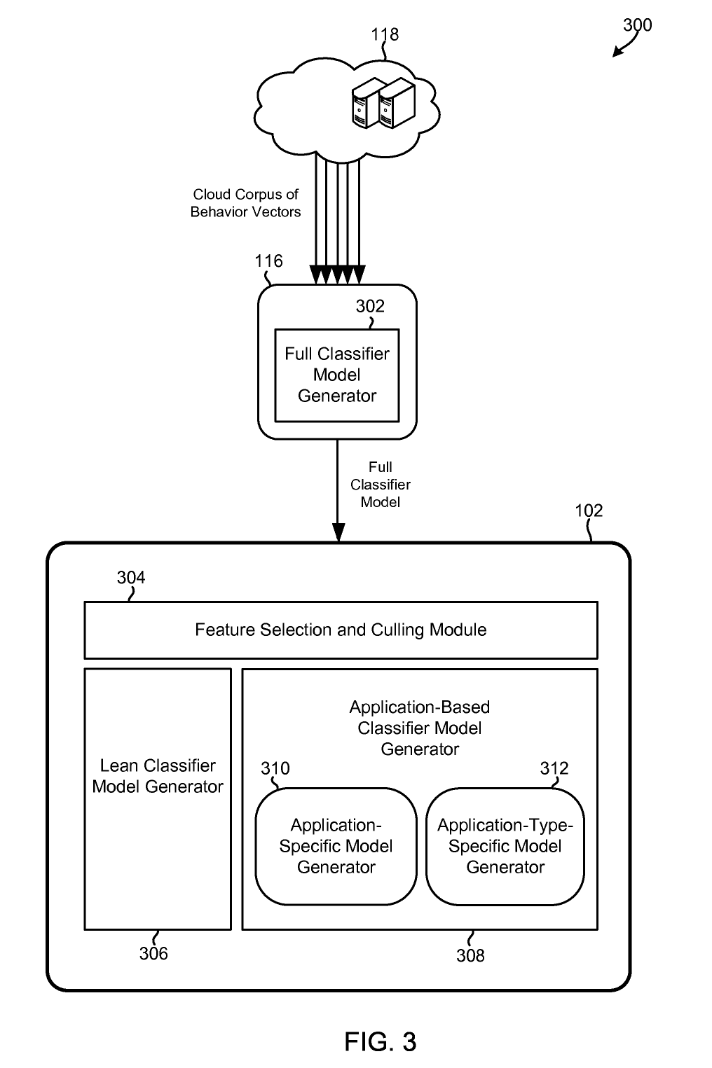

FIG. 3 illustrates example components and information flows in a system 300 that includes a network server 116 configured to work in conjunction with the computing device 102 to intelligently and efficiently identify performance-degrading computing device behaviors on the computing device 102 without consuming an excessive amount of processing, memory, or energy resources of the computing device 102. In the example illustrated in FIG. 3, the computing device 102 includes a feature selection and culling module 304, a lean classifier model generator module 306, and an application-based classifier model generator module 308, which may include an application-specific classifier model generator module 310 and an application-based classifier model generator module 312. The network server 116 includes a full classifier model generator module 302.

Any or all of the modules 304-312 may be a real-time online classifier module and/or included in the behavior analyzer module 204 or classifier module 208 illustrated in FIG. 2. In an aspect, the application-based classifier model generator module 308 may be included in the lean classifier model generator module 306. In various aspects, the feature selection and culling module 304 may be included in the application-based classifier model generator module 308 or in the lean classifier model generator module 306.

The network server 116 may be configured to receive information on various conditions, features, behaviors, and corrective actions from the cloud service/network 118, and use this information to generate a full classifier model that describes a large corpus of behavior information in a format or structure that can be quickly converted into one or more lean classifier models by the computing device 102. For example, the full classifier model generator module 302 in the network server 116 may use a cloud corpus of behavior vectors received from the cloud service/network 118 to generate a full classifier model, which may include a finite state machine description or representation of the large corpus of behavior information. The finite state machine may be an information structure that may be expressed as one or more decision nodes, such as a family of boosted decision stumps that collectively identify, describe, test, or evaluate all or many of the features and data points that are relevant to classifying computing device behavior.

The network server 116 may send the full classifier model to the computing device 102, which may receive and use the full classifier model to generate a reduced feature classifier model or a family of classifier models of varying levels of complexity or leanness. In various aspects, the reduced feature classifier models may be generated in the feature selection and culling module 304, lean classifier model generator module 306, the application-based classifier generator module 308, or any combination thereof. That is, the feature selection and culling module 304, lean classifier model generator module 306, and/or application-based classifier generator 308 modules of the computing device 102 may, collectively or individually, use the information included in the full classifier model received from the network server to generate one or more reduced feature classifier models that include a subset of the features and data points included in full classifier model.

For example, the lean classifier model generator module 306 and feature selection and culling module 304 may collectively cull the robust family of boosted decision stumps included in the finite state machine of the full classifier model received from the network server 116 to generate a reduced feature classifier model that includes a reduced number of boosted decision stumps and/or evaluates a limited number of test conditions. The culling of the robust family of boosted decision stumps may be accomplished by selecting a boosted decision stump, identifying all other boosted decision stumps that test or depend upon the same computing device feature as the selected decision stump, and adding the selected stump and all the identified other boosted decision stumps that test or depend upon the same computing device feature to an information structure. This process may then be repeated for a limited number of stumps or device features, so that the information structure includes all boosted decision stumps in the full classifier model that test or depend upon a small or limited number of different features or conditions. The computing device may then use this information structure as a lean classifier model to test a limited number of different features or conditions of the computing device, and to quickly classify a computing device behavior without consuming an excessive amount of the computing device's processing, memory, or energy resources.

The lean classifier model generator module 306 may be further configured to generate classifier models that are specific to the computing device and to a particular software application or process that may execute on the computing device. In this manner, one or more lean classifier models may be generated that preferentially or exclusively test features or elements that pertain to the computing device and that are of particular relevance to the software application. These device- and application-based-specific lean classifier models may be generated by the lean classifier model generator module 306 in one pass by selecting test conditions that are relevant to the application and pertain to the computing device. Alternatively, the lean classifier model generator module 306 may generate a device-specific lean classifier model including test conditions pertinent to the computing device, and from this lean classifier model, generate a further refined model that includes or prioritize those test conditions that are relevant to the application. As a further alternative, the lean classifier model generator module 306 may generate a lean classifier model that is relevant to the application, and then remove test conditions that are not relevant to computing device. For ease of description, the processes of generating a device-specific lean classifier model are described first, followed by processes of generating an application-based lean classifier model.

The lean classifier model generator module 306 may be configured to generate device-specific classifier models by using device-specific information of the computing device 102 to identify computing device-specific features (or test conditions) that are relevant or pertain to classifying a behavior of that specific computing device 102. The lean classifier model generator module 306 may use this information to generate the lean classifier models that preferentially or exclusively include, test, or depend upon the identified computing device-specific features or test conditions. The computing device 102 may then use these locally generated lean classifier models to classify the behavior of the computing device without consuming an excessive amount of the computing device's processing, memory, or energy resources. That is, by generating the lean classifier models locally in the computing device 102 to account for device-specific or device-state-specific features, the various aspects allow the computing device 102 to focus monitoring operations on the features or factors that are most important for identifying the source or cause of an undesirable behavior in that specific computing device 102.

The lean classifier model generator module 306 may also be configured to determine whether an operating system execution state of the software application/process is relevant to determining whether any of the monitored computing device behaviors are malicious or suspicious, and generate a lean classifier model that includes, identifies, or evaluates features or behaviors that take the operating system execution states into account. The computing device 102 may then use these locally generated lean classifier models to preferentially or exclusively monitor the operating system execution states of the software applications for which such determinations are relevant. This allows the computing device 102 to focus the device's operations on the most important features and functions of an application in order to better predict whether a behavior is benign. That is, by monitoring the operating system execution states of select software applications (or processes, threads, etc.), the various aspects allow the computing device 102 to better predict whether a behavior is benign or malicious. Further, by intelligently determining whether the operating system execution state of a software application is relevant to the determination of whether a behavior is benign or malicious—and selecting for monitoring the software applications (or processes, threads, etc.) for which such determinations are relevant—the various aspects allow the computing device 102 to better focus the device's operations and identify performance-degrading behaviors/factors without consuming an excessive amount of processing, memory, or energy resources of the computing device.

In an aspect, the feature selection and culling module 304 may be configured to allow for feature selection and generation of classifier models “on the fly” and without requiring that the computing device 102 to access the cloud data for retraining. This allows the application-based classifier model generator module 308 to generate/create classifier models in the computing device 102 that allow the computing device 102 to focus the device's operations on evaluating the features that relate to specific software applications or to specific types, classes, or categories of software applications.

That is, the application-based classifier model generator module 308 allows the computing device 102 to generate and use highly focused and lean classifier models that preferentially or exclusively test or evaluate the features of the computing device that are associated with an operation of a specific software application or with the operations that are typically performed by a certain type, class, or category of software applications. To accomplish this, the application-based classifier model generator module 308 may intelligently identify software applications that are at high-risk for abuse and/or are have a special need for security, and for each of these identified applications, determine the activities that the application can or will perform during execution. The application-specific classifier model generator module 308 may then associate these activities with data centric features of the computing device to generate classifier models that are well suited for use by the computing device in determining whether an individual software application is contributing to, or is likely to contribute to, a performance degrading behavior of the computing device 102.

The application-specific classifier model generator module 308 may be configured to generate application-specific and/or application-type-specific classifier models every time a new application is installed or updated in the computing device. This may be accomplished via the application specific model generator module 310 and/or application-type-specific model generator module 312.

The application-based-specific classifier model generator module 312 may be configured to generate a classifier model for a specific software application based on a category, type, or classification of that software application (e.g. game, navigation, financial, etc.). The application-based-specific classifier model generator module 312 may determine the category, type, or classification of the software application by reading an application store label associated with the software application, by performing static analysis operations, and/or by comparing the software application to other similar software applications.

For example, the application-based-specific classifier model generator module 312 may evaluate the permissions (e.g., operating system, file, access, etc.) and/or API usage patterns of a first software application, compare this information to the permissions or API usage pattern of a second software application to determine whether the first software application includes the same set of permissions or utilizes the same set of APIs as the second software application, and use labeling information of the second software application to determine a software application type (e.g., financial software, banking application, etc.) for the first software application when the first software application includes the same set of permissions or utilizes the same set of APIs as the second software application. The application-based-specific classifier model generator module 312 may then generate, update, or select a classifier model that is suitable for evaluating the first software application based on the determined software application type. In an aspect, this may be achieved by culling the decision nodes included in the full classifier model received from the network server 116 based on the determined software application type.

The application-specific classifier model generator module 310 may be configured to generate a classifier model for a specific software application based on labeling information, static analysis, install time analysis, or by determining the operating system, file, and/or access permissions of the software application. For example, the computing device may perform static analysis of the software application each time the software application is updated, store the results of this analysis in a memory of the computing device, use this information to determine the computing device conditions or factors that are most important for determining whether that application is contributing to a suspicious computing device behavior, and cull the decision nodes included in the full classifier model to include nodes that test the most important conditions or factors.

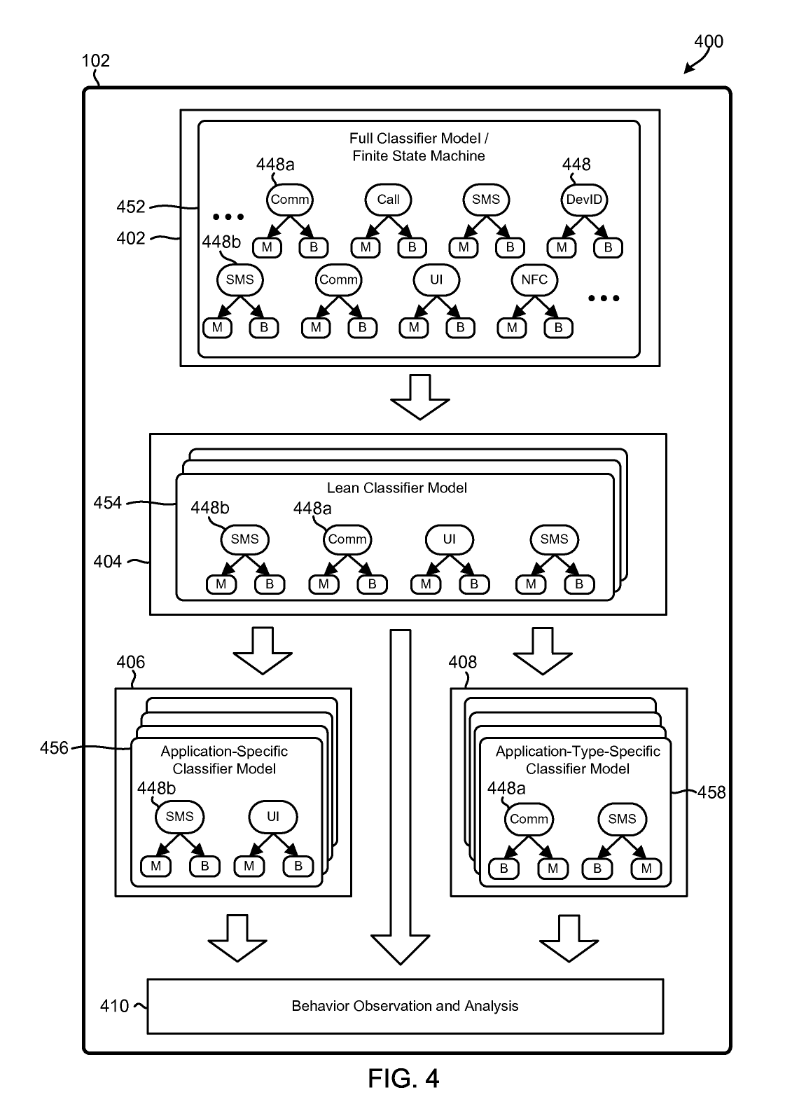

FIG. 4 illustrates an aspect method 400 of generating application-specific and/or application-based-specific classifier models in a computing device 102. Method 400 may be performed by a processing core of a computing device 102.

In block 402, the processing core may use information included in a full classifier model 452 to generate a large number of decision nodes 448 that collectively identify, describe, test, or evaluate all or many of the features and data points that are relevant to determining whether a computing device behavior is benign or contributing to the degradation in performance or power consumption characteristics of the computing device 102 over time. For example, in block 402, the processing core may generate one-hundred (100) decision nodes 448 that test forty (40) unique conditions.

In an aspect, the decision nodes 448 may be decision stumps (e.g., boosted decision stumps, etc.). Each decision stump may be a one level decision tree that has exactly one node that tests one condition or computing device feature. Because there is only one node in a decision stump, applying a feature vector to a decision stump results in a binary answer (e.g., yes or no, malicious or benign, etc.). For example, if the condition tested by a decision stump 448b is “is the frequency of SMS transmissions less than x per min,” applying a value of “3” to the decision stump 448b will result in either a “yes” answer (for “less than 3” SMS transmissions) or a “no” answer (for “3 or more” SMS transmissions). This binary “yes” or “no” answer may then be used to classify the result as indicating that the behavior is either malicious (M) or benign (B). Since these stumps are very simple evaluations (basically binary), the processing to perform each stump is very simple and can be accomplished quickly and/or in parallel with less processing overhead.

In an aspect, each decision node 448 may be associated a weight value that is indicative of how much knowledge is gained from answering the test question and/or the likelihood that answering the test condition will enable the processing core to determine whether a computing device behavior is benign. The weight associated with a decision node 448 may be computed based on information collected from previous observations or analysis of computing device behaviors, software applications, or processes in the computing device. In an aspect, the weight associated with each decision node 448 may also be computed based on how many units of the corpus of data (e.g., cloud corpus of data or behavior vectors) are used to build the node. In an aspect, the weight values may be generated based on the accuracy or performance information collected from the execution/application of previous data/behavior models or classifiers.

Returning to FIG. 4, in block 404, the processing core may generate a lean classifier model 454 that includes a focused subset of the decision nodes 448 included in the full classifier model 452. To accomplish this, the processing core may perform feature selection operations, which may include generating an ordered or prioritized list of the decision nodes 448 included in the full classifier model 452, determining a number of unique test conditions that should be evaluated to classify a computing device behavior without consuming an excessive amount of processing, memory, or energy resources of the computing device 102, generating a list of test conditions by sequentially traversing the ordered/prioritized list of decision nodes 448 and inserting a test condition associated with each sequentially traversed decision node 448 into the list of test conditions until the list of test conditions includes the determined number of unique test conditions, and generating an information structure that preferentially or exclusively includes the decision nodes 448 that test one of the test conditions included in the generated list of test conditions. In an aspect, the processing core may generate a family classifier models so that each model 454 in the family of classifier models evaluates a different number of unique test conditions and/or includes a different number of decision nodes.

In block 406, the processing core may trim, cull, or prune the decision nodes (i.e., boosted decision stumps) included in one of the lean classifier models 454 to generate an application-specific classifier model 456 that preferentially or exclusively includes the decision nodes in the lean classifier model 454 that test or evaluate conditions or features that are relevant to a specific software application (i.e., Google® wallet), such as by dropping decision nodes that address API's or functions that are not called or invoked by the application, as well as dropping decision nodes regarding device resources that are not accessed or modified by the application. In an aspect, the processing core may generate the application-specific classifier model 456 by performing feature selection and culling operations. In various aspects, the processing core may identify decision nodes 448 for inclusion in an application-specific classifier model 456 based on labeling information associated with a software application, the results of performing static analysis operations on the application, the results of performing install time analysis of the application, by evaluating the operating system, file, and/or access permissions of the software application, by evaluating the API usage of the application, etc.

In an aspect, in block 406, the processing core may generate a plurality of application-specific classifier models 456, each of which evaluate a different software application. In an aspect, the processing core may generate an application-specific classifier model 456 for every software application in the system and/or so that every application running on the computing device has an active classifier model specific to the respective application. In an aspect, in block 406, the processing core may generate a family of application-specific classifier models 456. Each application-specific classifier model 456 in the family of application-specific classifier models 456 may evaluate a different combination or number of the features that are relevant to a single software application.

In block 408, the processing core may trim, cull, or prune the decision nodes (i.e., boosted decision stumps) included in one of the lean classifier models 454 to generate application-based-specific classifier models 458. The generated application-based classifier models 458 may preferentially or exclusively include the decision nodes that are included in the full or lean classifier models 452, 454 that test or evaluate conditions or features that are relevant to a specific type, category, group, or class of software applications (e.g. game, navigation, financial, etc.). In an aspect, the processing core may identify the decision nodes for inclusion in the application-based classifier model 458 by performing feature selection and culling operations. In an aspect, the processing core may determine the category, type, or classification of each software application and/or identify the decision nodes 448 that are to be included in an application-based-specific classifier model 456 by reading an application store label associated with the software application, by performing static analysis operations, and/or by comparing the software application to other similar software applications.

In block 410, the processing core may use one or any combination of the locally generated classifier models 454, 456, 458 to perform real-time behavior monitoring and analysis operations, and predict whether a complex computing device behavior is benign or contributing to the degradation of the performance or power consumption characteristics of the computing device. In an aspect, the computing device may be configured use or apply multiple classifier models 454, 456, 458 in parallel. In an aspect, the processing core may give preference or priority to the results generated from applying or using application-based classifier models 456, 458 over the results generated from applying/using the lean classifier model 454 when evaluating a specific software application. The processing core may use the results of applying the classifier models to predict whether a complex computing device behavior is benign or contributing to the degradation of the performance or power consumption characteristics of the computing device over time.

By dynamically generating the application-based classifier models 456, 458 locally in the computing device to account for application-specific or application-based-specific features and/or functionality, the various aspects allow the computing device 102 to focus the device's monitoring operations on a small number of features that are most important for determining whether the operations of a specific software application are contributing to an undesirable or performance depredating behavior of the computing device. This improves the performance and power consumption characteristics of the computing device 102, and allows the computing device to perform the real-time behavior monitoring and analysis operations continuously or near continuously without consuming an excessive amount of the computing device's processing, memory, or energy resources.

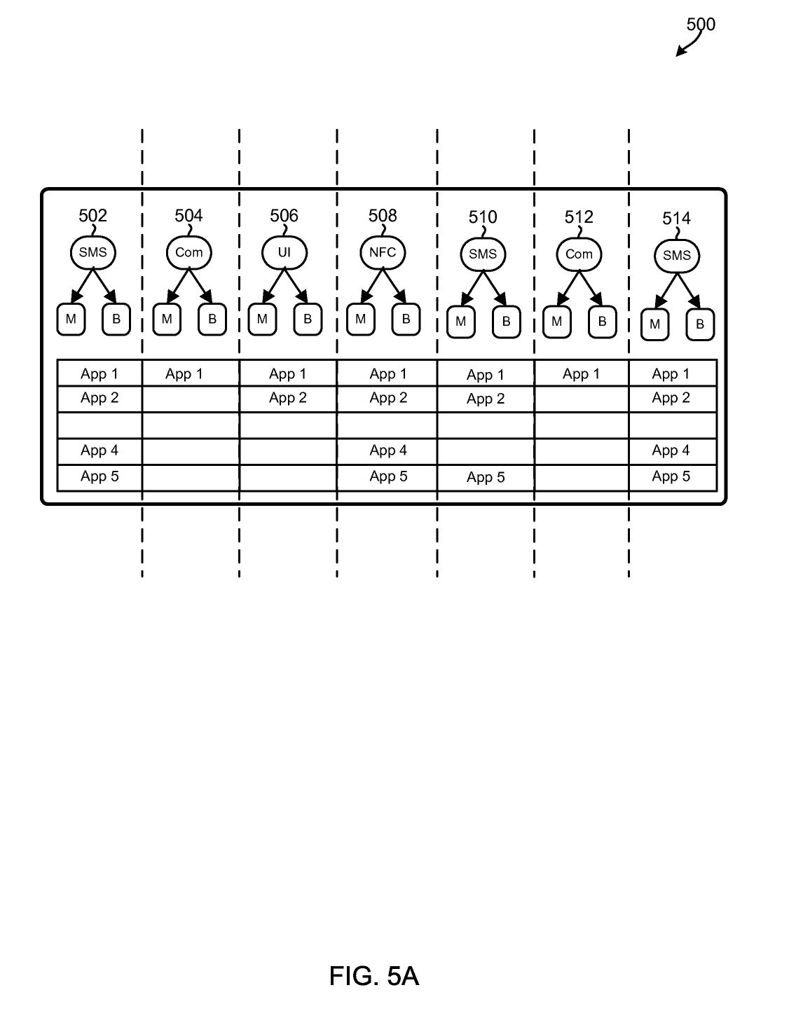

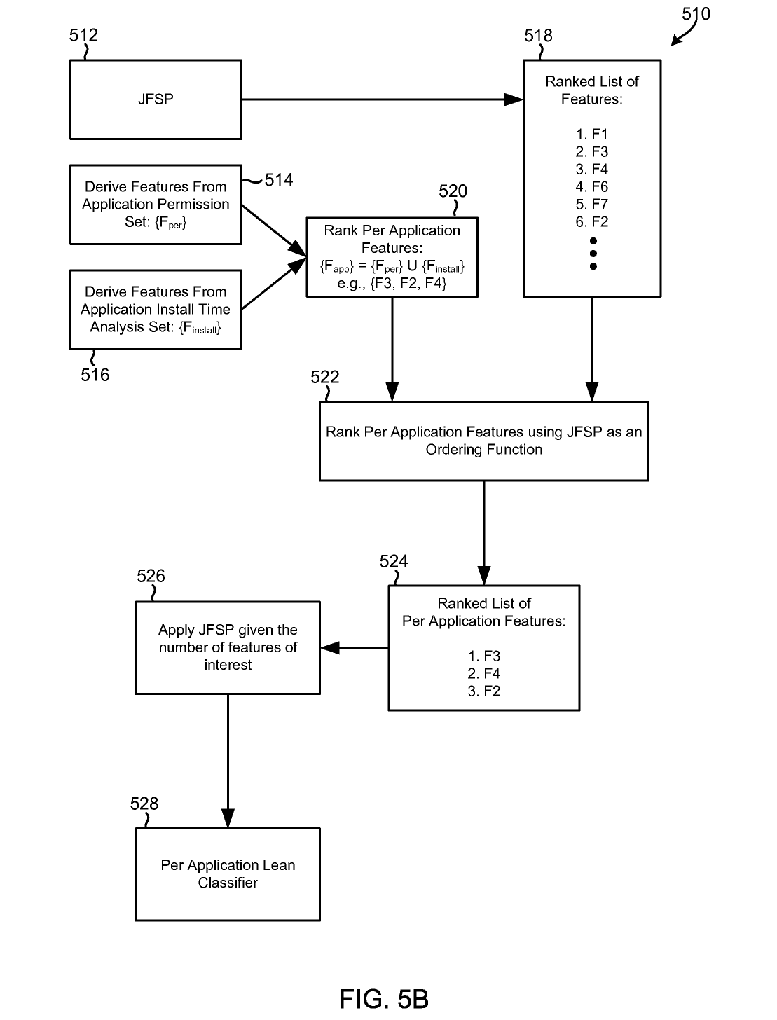

FIG. 5A illustrates an example classifier model 500 that may be used by an aspect computing device 102 to apply a behavior vector to multiple application-based classifier models in parallel. The classifier model 500 may be a full classifier model or a locally generated lean classifier model. The classifier model 500 may include a plurality of decision nodes 502-514 that are associated with one or more software applications App1-App5. For example, in FIG. 5A decision node 502 is associated with software applications App1, App2, App4, and App5, decision node 504 is associated with App1, decision node 506 is associated with App1 and App2, decision node 508 is associated with software applications App1, App2, App4, and App5, decision node 510 is associated with software applications App1, App2, and App5, decision node 512 is associated with software applications App1, and decision node 514 is associated with software applications App1, App2, App4, and App5.

In an aspect, a processing core in the computing device may be configured to use the mappings between the decision nodes 502-514 and the software applications App1-App5 to partition the classifier model 500 into a plurality of application-based classifier models. For example, the processor may use the mappings to determine that an application-based classifier for App1 should include decision nodes 502-514, whereas an application-based classifier for App1 should include decision nodes 502, 506, 508, 510, and 514. That is, rather than generating and executing a different classifier model for each software application, the processing core may apply a behavior vector to all the decision nodes 502-514 included in the classifier model 500 to execute the same set of decision nodes 502-514 for all the classifiers. For each application App1-App5, the computing device may apply a mask (e.g., a zero-one mask) to the classifier model 500 so that the decision nodes 502-514 that are relent to the application App1-App5 are used or prioritized to evaluate device behaviors when that application is executing.

In an aspect, the computing device may calculate different weight values or different weighted averages for the decision nodes 502-514 based on their relevance to their corresponding application App1-App5. Computing such a confidence for the malware/benign value may include evaluating a number of decision nodes 502-514 and taking a weighted average of their weight values. In an aspect, the computing device may compute the confidence value over the same or different lean classifiers. In an aspect, the computing device may compute different weighted averages for each combination of decision nodes 502-514 that make up a classifier.

FIG. 5B illustrates an aspect method 510 of generating classifier models that account for application-specific and application-based-specific features of a computing device. Method 510 may be performed by a processing core in a computing device.

In block 512, the processing core may perform joint feature selection and culling (JFSP) operations to generate a lean classifier model that includes a reduced number of decision nodes and features/test conditions. In block 518, the processing core may prioritize or rank the features/test conditions in accordance with their relevance to classifying a behavior of the computing device.

In block 514, the processing core may derive or determine features/test conditions for a software application by evaluating that application's permission set {Fper}. In block 516, the processing core may determine the set of features or test conditions {Finstall} for a software application by evaluating the results of performing static or install time analysis on that application. In block 520, the processing core may prioritize or rank the features/test conditions for each application in accordance with their relevance to classifying a behavior of the computing device. In an aspect, this may be accomplished by via the formula:

{Fapp}={Fper} U {Finstall}

In block 522, the processing core may prioritize or rank the per application features {Fapp} by using JFSP as an ordering function. For example, the processing core may perform JFSP operations on the lean classifier generated in block 518. In block 524, the processing core may generate the ranked list of per application features {Fapp}. In block 526, the processing core may apply JFSP to select the features of interest. In block 528, the processing core may generate the per application lean classifier model to include the features of interest.

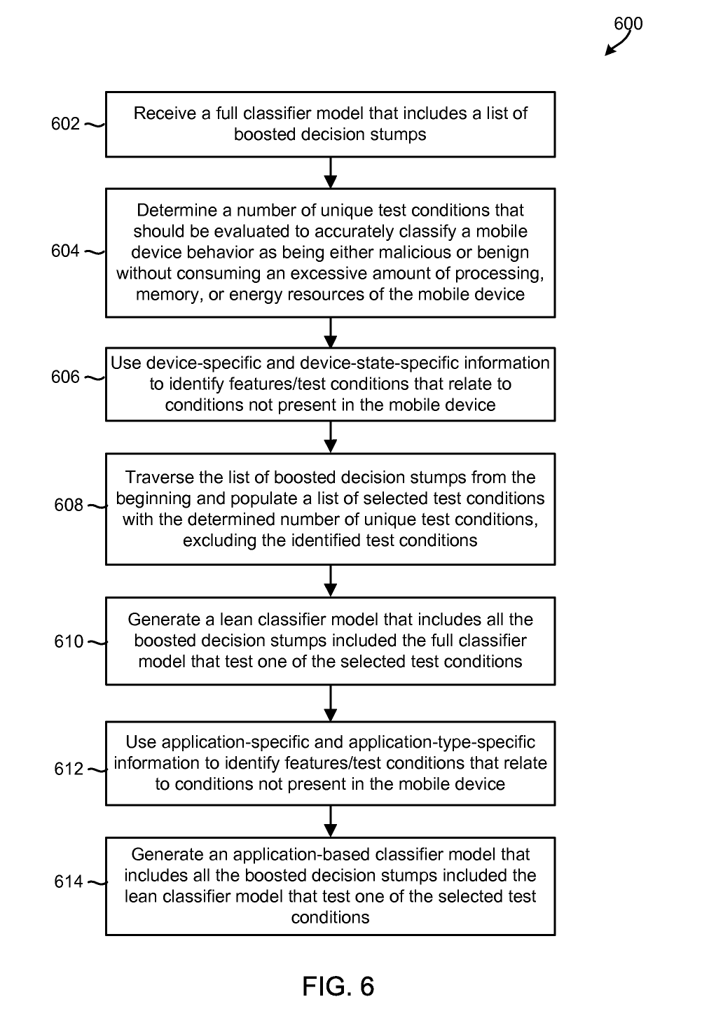

FIG. 6 illustrates an aspect method 600 of generating a lean or focused classifier/behavior models that account for application-specific and application-based-specific features of a computing device.

In block 602 of method 600, the processing core may receive a full classifier model that is or includes a finite state machine, a list of boosted decision trees, stumps or other similar information structure that identifies a plurality of test conditions. In an aspect, the full classifier model includes a finite state machine that includes information suitable for expressing plurality of boosted decision stumps and/or which include information that is suitable for conversion by the computing device into a plurality of boosted decision stumps. In an aspect, the finite state machine may be (or may include) an ordered or prioritized list of boosted decision stumps. Each of the boosted decision stumps may include a test condition and a weight value.

In block 604, the processing core may determine the number unique test conditions that should be evaluated to accurately classify a computing device behavior as being either malicious or benign without consuming an excessive amount of processing, memory, or energy resources of the computing device. This may include determining an amount of processing, memory, and/or energy resources available in the computing device, the amount processing, memory, or energy resources of the computing device that are required to test a condition, determining a priority and/or a complexity associated with a behavior or condition that is to be analyzed or evaluated in the computing device by testing the condition, and selecting/determining the number of unique test conditions so as to strike a balance or tradeoff between the consumption of available processing, memory, or energy resources of the computing device, the accuracy of the behavior classification that is to be achieved from testing the condition, and the importance or priority of the behavior that is tested by the condition.

In block 606, the processing core may use device-specific or device-state-specific information to quickly identify the features and/or test conditions that should be included or excluded from the lean classifier models. For example, the processing core may identify the test conditions that test conditions, features, or factors that cannot be present in the computing device due to the computing device's current hardware or software configuration, operating state, etc. As another example, the processing core may identify and exclude from the lean classifier models the features/nodes/stumps that are included in the full model and test conditions that cannot exist in the computing device and/or which are not relevant to the computing device.

In an aspect, in block 608, the processing core may traverse the list of boosted decision stumps from the beginning to populate a list of selected test conditions with the determined number of unique test conditions and to exclude the test conditions identified in block 606. For example, the processing core may skip, ignore, or delete features included in the full classifier model that test conditions that cannot be used by the software application. In an aspect, the processing core may also determine an absolute or relative priority value for each of the selected test conditions, and store the absolute or relative priorities value in association with their corresponding test conditions in the list of selected test conditions.

In an aspect, in block 608, the processing core may generating a list of test conditions by sequentially traversing the plurality of test conditions in the full classifier model and inserting those test conditions that are relevant to classifying the behavior of the computing device into the list of test conditions until the list of test conditions includes the determined number of unique test conditions. In a further aspect, generating the list of test conditions may include sequentially traversing the decision nodes of the full classifier model, ignoring decision nodes associated with test conditions not relevant to the software application, and inserting test conditions associated with each sequentially traversed decision node that is not ignored into the list of test conditions until the list of test conditions includes the determined number of unique test conditions.

In block 610, the processing core may generate a lean classifier model that includes all the boosted decision stumps included in the full classifier model that test one of the selected test conditions (and thus exclude the test conditions identified in block 606) identified in the generated list of test conditions. In an aspect, the processing core may generate the lean classifier model to include or express the boosted decision stumps in order of their importance or priority value. In an aspect, in block 610, the processing core may increase the number of unique test conditions in order to generate another more robust (i.e., less lean) lean classifier model by repeating the operations of traversing the list of boosted decision stumps for a larger number test conditions in block 608 and generating another lean classifier mode. These operations may be repeated to generate a family of lean classifier models.

In block 612, the processing core may use application-specific information and/or application-based information to identify features or test conditions that are included in the lean classifier model and which are relevant to determining whether a software application is contributing to a performance degrading behavior of a computing device. In block 614, the processing core may traverse the boosted decision stumps in the lean classifier model and select or map the decision stumps that test a feature or condition that is used by a software application to that software application, and use the selected or mapped decision stumps as an application-specific classifier model or an application-based-specific classifier model.

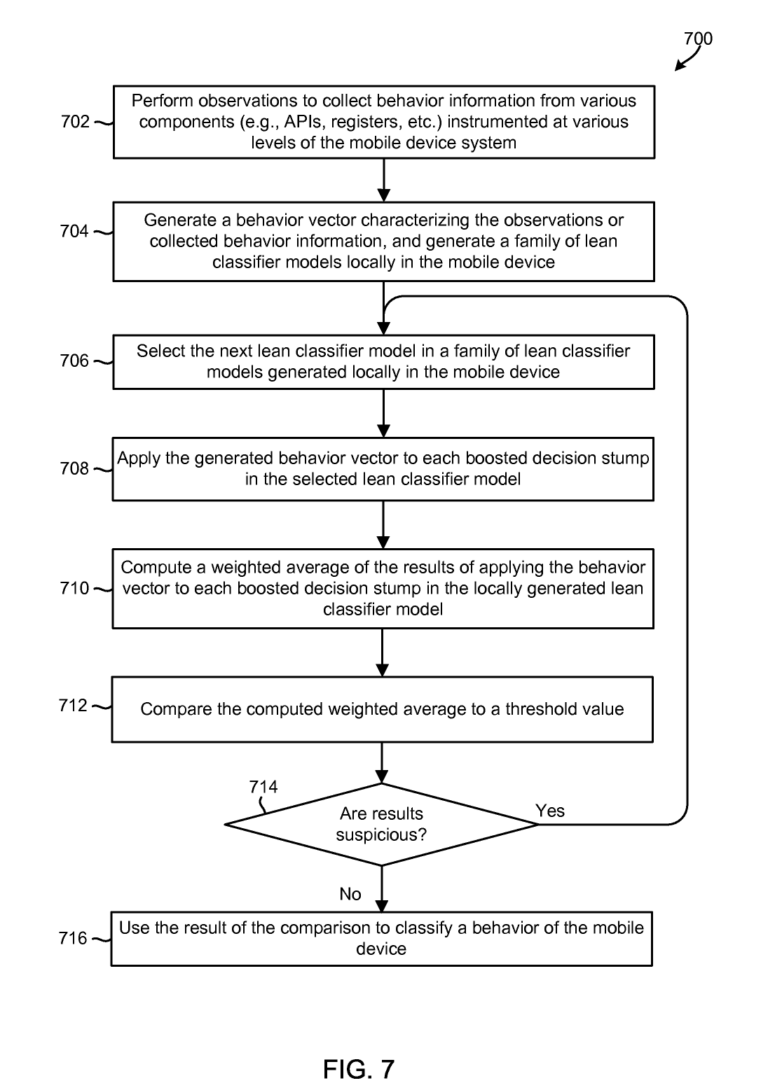

FIG. 7 illustrates an aspect method 700 of using a lean classifier model to classify a behavior of the computing device. Method 700 may be performed by a processing core in a computing device.

In block 702, the processing core my perform observations to collect behavior information from various components that are instrumented at various levels of the computing device system. In an aspect, this may be accomplished via the behavior observer module 202 discussed above with reference to FIG. 2. In block 704, the processing core may generate a behavior vector characterizing the observations, the collected behavior information, and/or a computing device behavior. Also in block 704, the processing core may use a full classifier model received from a network server to generate a lean classifier model or a family of lean classifier models of varying levels of complexity (or “leanness”). To accomplish this, the processing core may cull a family of boosted decision stumps included in the full classifier model to generate lean classifier models that include a reduced number of boosted decision stumps and/or evaluate a limited number of test conditions.

In block 706, the processing core may select the leanest classifier in the family of lean classifier models (i.e., the model based on the fewest number of different computing device states, features, behaviors, or conditions) that has not yet been evaluated or applied by the computing device. In an aspect, this may be accomplished by the processing core selecting the first classifier model in an ordered list of classifier models.

In block 708, the processing core may apply collected behavior information or behavior vectors to each boosted decision stump in the selected lean classifier model. Because boosted decision stumps are binary decisions and the lean classifier model is generated by selecting many binary decisions that are based on the same test condition, the process of applying a behavior vector to the boosted decision stumps in the lean classifier model may be performed in a parallel operation. Alternatively, the behavior vector applied in block 530 may be truncated or filtered to just include the limited number of test condition parameters included in the lean classifier model, thereby further reducing the computational effort in applying the model.

In block 710, the processing core may compute or determine a weighted average of the results of applying the collected behavior information to each boosted decision stump in the lean classifier model. In block 712, the processing core may compare the computed weighted average to a threshold value. In determination block 714, the processing core may determine whether the results of this comparison and/or the results generated by applying the selected lean classifier model are suspicious. For example, the processing core may determine whether these results may be used to classify a behavior as either malicious or benign with a high degree of confidence, and if not treat the behavior as suspicious.

If the processing core determines that the results are suspicious (e.g., determination block 714=“Yes”), the processing core may repeat the operations in blocks 706-712 to select and apply a stronger (i.e., less lean) classifier model that evaluates more device states, features, behaviors, or conditions until the behavior is classified as malicious or benign with a high degree of confidence. If the processing core determines that the results are not suspicious (e.g., determination block 714=“No”), such as by determining that the behavior can be classified as either malicious or benign with a high degree of confidence, in block 716, the processing core may use the result of the comparison generated in block 712 to classify a behavior of the computing device as benign or potentially malicious.

In an alternative aspect method, the operations described above may be accomplished by sequentially selecting a boosted decision stump that is not already in the lean classifier model; identifying all other boosted decision stumps that depend upon the same computing device state, feature, behavior, or condition as the selected decision stump (and thus can be applied based upon one determination result); including in the lean classifier model the selected and all identified other boosted decision stumps that depend upon the same computing device state, feature, behavior, or condition; and repeating the process for a number of times equal to the determined number of test conditions. Because all boosted decision stumps that depend on the same test condition as the selected boosted decision stump are added to the lean classifier model each time, limiting the number of times this process is performed will limit the number of test conditions included in the lean classifier model.

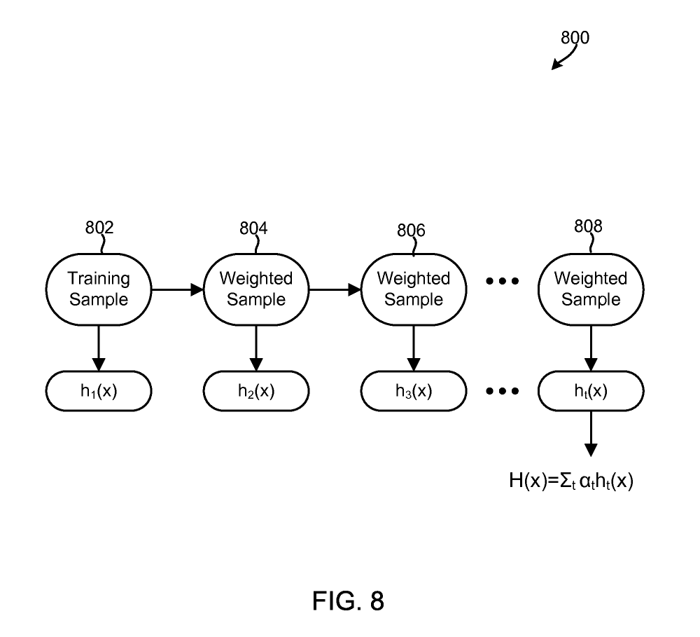

FIG. 8 illustrates an example boosting method 800 suitable for generating a boosted decision tree/classifier that is suitable for use in accordance with various aspects. In operation 802, a processor may generate and/or execute a decision tree/classifier, collect a training sample from the execution of the decision tree/classifier, and generate a new classifier model (h1(x)) based on the training sample. The training sample may include information collected from previous observations or analysis of computing device behaviors, software applications, or processes in the computing device. The training sample and/or new classifier model (h1(x)) may be generated based the types of question or test conditions included in previous classifiers and/or based on accuracy or performance characteristics collected from the execution/application of previous data/behavior models or classifiers in a classifier module 208 of a behavior analyzer module 204. In operation 804, the processor may boost (or increase) the weight of the entries that were misclassified by the generated decision tree/classifier (h1(x)) to generate a second new tree/classifier (h2(x)). In an aspect, the training sample and/or new classifier model (h2(x)) may be generated based on the mistake rate of a previous execution or use (h1(x)) of a classifier. In an aspect, the training sample and/or new classifier model (h2(x)) may be generated based on attributes determined to have that contributed to the mistake rate or the misclassification of data points in the previous execution or use of a classifier.

In an aspect, the misclassified entries may be weighted based on their relatively accuracy or effectiveness. In operation 806, the processor may boost (or increase) the weight of the entries that were misclassified by the generated second tree/classifier (h2(x)) to generate a third new tree/classifier (h3(x)). In operation 808, the operations of 804-806 may be repeated to generate “t” number of new tree/classifiers (hₜ(x)).

By boosting or increasing the weight of the entries that were misclassified by the first decision tree/classifier (h1(x)), the second tree/classifier (h2(x)) may more accurately classify the entities that were misclassified by the first decision tree/classifier (h1(x)), but may also misclassify some of the entities that where correctly classified by the first decision tree/classifier (h1(x)). Similarly, the third tree/classifier (h3(x)) may more accurately classify the entities that were misclassified by the second decision tree/classifier (h2(x)) and misclassify some of the entities that where correctly classified by the second decision tree/classifier (h2(x)). That is, generating the family of tree/classifiers h1(x)-hₜ(x) may not result in a system that converges as a whole, but results in a number of decision trees/classifiers that may be executed in parallel.

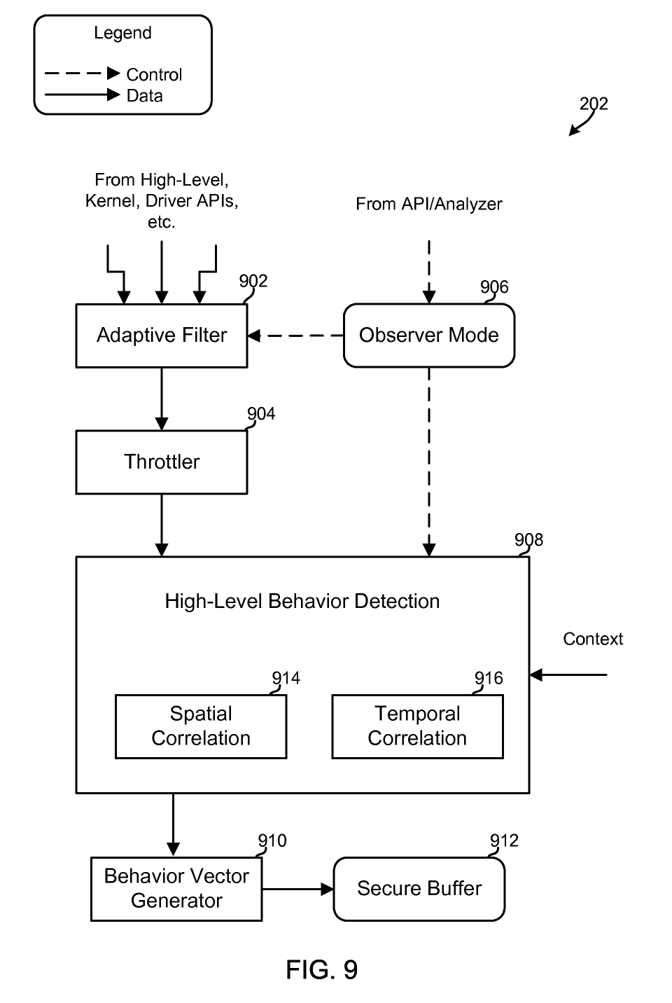

FIG. 9 illustrates example logical components and information flows in a behavior observer module 202 of a computing system configured to perform dynamic and adaptive observations in accordance with an aspect. The behavior observer module 202 may include an adaptive filter module 902, a throttle module 904, an observer mode module 906, a high-level behavior detection module 908, a behavior vector generator 910, and a secure buffer 912. The high-level behavior detection module 908 may include a spatial correlation module 914 and a temporal correlation module 916.

The observer mode module 906 may receive control information from various sources, which may include an analyzer unit (e.g., the behavior analyzer module 204 described above with reference to FIG. 2) and/or an application API. The observer mode module 906 may send control information pertaining to various observer modes to the adaptive filter module 902 and the high-level behavior detection module 908.

The adaptive filter module 902 may receive data/information from multiple sources, and intelligently filter the received information to generate a smaller subset of information selected from the received information. This filter may be adapted based on information or control received from the analyzer module, or a higher-level process communicating through an API. The filtered information may be sent to the throttle module 904, which may be responsible for controlling the amount of information flowing from the filter to ensure that the high-level behavior detection module 908 does not become flooded or overloaded with requests or information.

The high-level behavior detection module 908 may receive data/information from the throttle module 904, control information from the observer mode module 906, and context information from other components of the computing device. The high-level behavior detection module 908 may use the received information to perform spatial and temporal correlations to detect or identify high level behaviors that may cause the device to perform at sub-optimal levels. The results of the spatial and temporal correlations may be sent to the behavior vector generator 910, which may receive the correlation information and generate a behavior vector that describes the behaviors of a particular process, application, or sub-system. In an aspect, the behavior vector generator 910 may generate the behavior vector such that each high-level behavior of a particular process, application, or sub-system is an element of the behavior vector. In an aspect, the generated behavior vector may be stored in a secure buffer 912. Examples of high-level behavior detection may include detection of the existence of a particular event, the amount or frequency of another event, the relationship between multiple events, the order in which events occur, time differences between the occurrence of certain events, etc.

In the various aspects, the behavior observer module 202 may perform adaptive observations and control the observation granularity. That is, the behavior observer module 202 may dynamically identify the relevant behaviors that are to be observed, and dynamically determine the level of detail at which the identified behaviors are to be observed. In this manner, the behavior observer module 202 enables the system to monitor the behaviors of the computing device at various levels (e.g., multiple coarse and fine levels). The behavior observer module 202 may enable the system to adapt to what is being observed. The behavior observer module 202 may enable the system to dynamically change the factors/behaviors being observed based on a focused subset of information, which may be obtained from a wide verity of sources.

As discussed above, the behavior observer module 202 may perform adaptive observation techniques and control the observation granularity based on information received from a variety of sources. For example, the high-level behavior detection module 908 may receive information from the throttle module 904, the observer mode module 906, and context information received from other components (e.g., sensors) of the computing device. As an example, a high-level behavior detection module 908 performing temporal correlations might detect that a camera has been used and that the computing device is attempting to upload the picture to a server. The high-level behavior detection module 908 may also perform spatial correlations to determine whether an application on the computing device took the picture while the device was holstered and attached to the user's belt. The high-level behavior detection module 908 may determine whether this detected high-level behavior (e.g., usage of the camera while holstered) is a behavior that is acceptable or common, which may be achieved by comparing the current behavior with past behaviors of the computing device and/or accessing information collected from a plurality of devices (e.g., information received from a crowd-sourcing server). Since taking pictures and uploading them to a server while holstered is an unusual behavior (as may be determined from observed normal behaviors in the context of being holstered), in this situation the high-level behavior detection module 908 may recognize this as a potentially threatening behavior and initiate an appropriate response (e.g., shutting off the camera, sounding an alarm, etc.).

In an aspect, the behavior observer module 202 may be implemented in multiple parts.

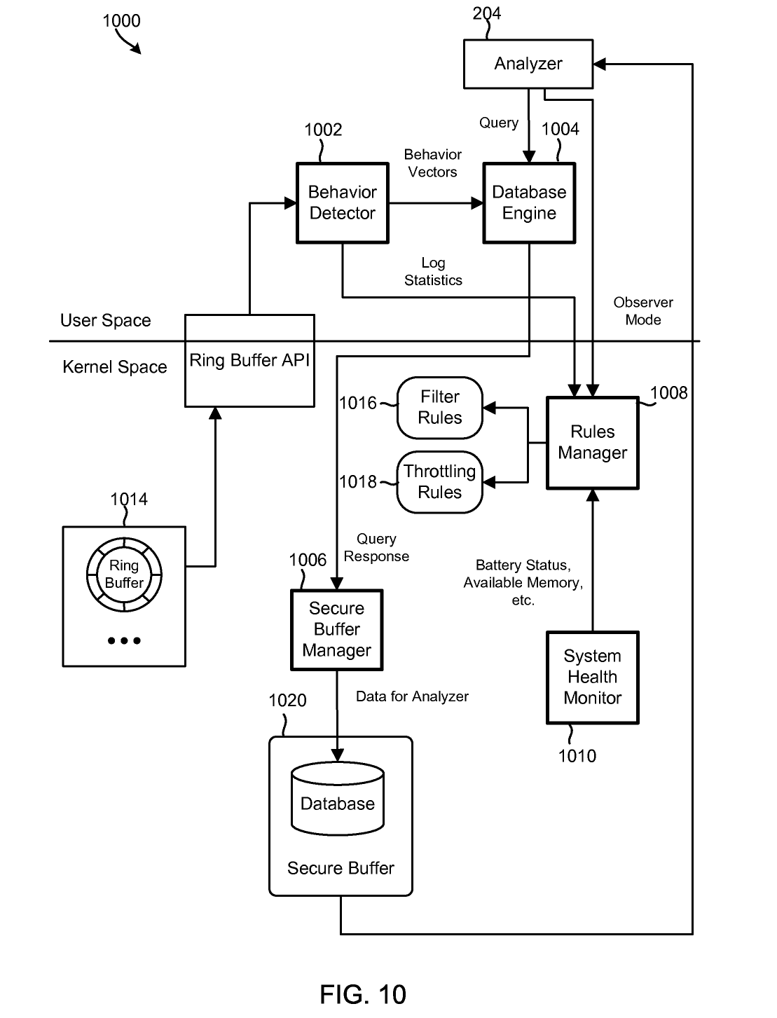

FIG. 10 illustrates in more detail logical components and information flows in a computing system 1000 implementing an aspect observer daemon. In the example illustrated in FIG. 10, the computing system 1000 includes a behavior detector 1002 module, a database engine 1004 module, and a behavior analyzer module 204 in the user space, and a ring buffer 1014, a filter rules 1016 module, a throttling rules 1018 module, and a secure buffer 1020 in the kernel space. The computing system 1000 may further include an observer daemon that includes the behavior detector 1002 and the database engine 1004 in the user space, and the secure buffer manager 1006, the rules manager 1008, and the system health monitor 1010 in the kernel space.

The various aspects may provide cross-layer observations on computing devices encompassing webkit, SDK, NDK, kernel, drivers, and hardware in order to characterize system behavior. The behavior observations may be made in real time.

The observer module may perform adaptive observation techniques and control the observation granularity. As discussed above, there are a large number (i.e., thousands) of factors that could contribute to the computing device's degradation, and it may not be feasible to monitor/observe all of the different factors that may contribute to the degradation of the device's performance. To overcome this, the various aspects dynamically identify the relevant behaviors that are to be observed, and dynamically determine the level of detail at which the identified behaviors are to be observed.

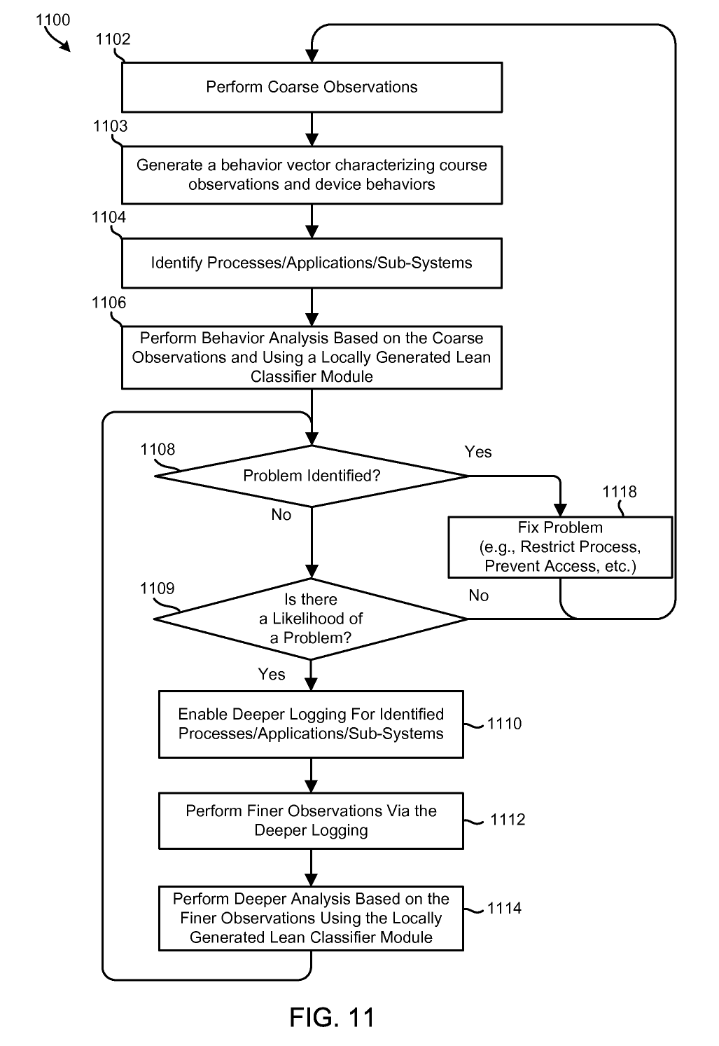

FIG. 11 illustrates an example method 1100 for performing dynamic and adaptive observations in accordance with an aspect. In block 1102, the computing device processor may perform coarse observations by monitoring/observing a subset of a large number factors/behaviors that could contribute to the computing device's degradation. In block 1103, the computing device processor may generate a behavior vector characterizing the coarse observations and/or the computing device behavior based on the coarse observations. In block 1104, the computing device processor may identify subsystems, processes, and/or applications associated with the coarse observations that may potentially contribute to the computing device's degradation. This may be achieved, for example, by comparing information received from multiple sources with contextual information received from sensors of the computing device. In block 1106, the computing device processor may perform behavioral analysis operations based on the coarse observations. In an aspect, as part of blocks 1103 and 1104, the computing device processor may perform one or more of the operations discussed above with reference to FIGS. 2-10.

In determination block 1108, the computing device processor may determine whether suspicious behaviors or potential problems can be identified and corrected based on the results of the behavioral analysis. When the computing device processor determines that the suspicious behaviors or potential problems can be identified and corrected based on the results of the behavioral analysis (i.e., determination block 1108=“Yes”), in block 1118, the processor may initiate a process to correct the behavior and return to block 1102 to perform additional coarse observations.

When the computing device processor determines that the suspicious behaviors or potential problems cannot be identified and/or corrected based on the results of the behavioral analysis (i.e., determination block 1108=“No”), in determination block 1109 the computing device processor may determine whether there is a likelihood of a problem. In an aspect, the computing device processor may determine that there is a likelihood of a problem by computing a probability of the computing device encountering potential problems and/or engaging in suspicious behaviors, and determining whether the computed probability is greater than a predetermined threshold. When the computing device processor determines that the computed probability is not greater than the predetermined threshold and/or there is not a likelihood that suspicious behaviors or potential problems exist and/or are detectable (i.e., determination block 1109=“No”), the processor may return to block 1102 to perform additional coarse observations.

When the computing device processor determines that there is a likelihood that suspicious behaviors or potential problems exist and/or are detectable (i.e., determination block 1109=“Yes”), in block 1110, the computing device processor may perform deeper logging/observations or final logging on the identified subsystems, processes or applications. In block 1112, the computing device processor may perform deeper and more detailed observations on the identified subsystems, processes or applications. In block 1114, the computing device processor may perform further and/or deeper behavioral analysis based on the deeper and more detailed observations. In determination block 1108, the computing device processor may again determine whether the suspicious behaviors or potential problems can be identified and corrected based on the results of the deeper behavioral analysis. When the computing device processor determines that the suspicious behaviors or potential problems cannot be identified and corrected based on the results of the deeper behavioral analysis (i.e., determination block 1108=“No”), the processor may repeat the operations in blocks 1110-1114 until the level of detail is fine enough to identify the problem or until it is determined that the problem cannot be identified with additional detail or that no problem exists.

When the computing device processor determines that the suspicious behaviors or potential problems can be identified and corrected based on the results of the deeper behavioral analysis (i.e., determination block 1108=“Yes”), in block 1118, the computing device processor may perform operations to correct the problem/behavior, and the processor may return to block 1102 to perform additional operations.

In an aspect, as part of blocks 1102-1118 of method 1100, the computing device processor may perform real-time behavior analysis of the system's behaviors to identify suspicious behaviors from limited and coarse observations, to dynamically determine the behaviors to observe in greater detail, and to dynamically determine the precise level of detail required for the observations. This enables the computing device processor to efficiently identify and prevent problems from occurring, without requiring the use of a large amount of processor, memory, or battery resources on the device.

The various aspects may further include methods, and computing devices configured to implement the methods of generating application group or type groups for use in generating application-based classifier models (i.e., data or behavior models), which may be used to improve the efficiency and performance of a comprehensive behavioral monitoring and analysis system, and to enable the computing device to better predict whether a software application is a source or cause of an undesirable or performance depredating behavior of the computing device. The term “application group” is used herein to refer to a grouping or clustering of applications grouped using one or more clustering algorithms and having common behavior features (e.g., common API calls, frequent biometric sensor usage, etc.). Application groups as used herein are not limited to broad categories of applications such as commonly used “games,” “exercise,” or “financial” labels, but may instead pertain to applications features and behaviors (e.g., those that access a mobile wallet, those that continuously transmit location data, those that access a pedometer feature, etc.).

In various aspects, the computing device may be configured to generate application groups using clustering algorithms (e.g., unsupervised machine learning techniques) to separate applications of the computing device into clusters based on commonality of application behavior vector features. The computing device may be configured to retain and observe user input regarding whitelisting of application features classified by the system as being high risk or malicious. Using the whitelist history for features of applications within an application group, the computing device may be configured to generate application-based full or lean classifier models for each software application group in the system. The computing device may also be configured to dynamically identify new whitelist related input from a user and to modify an existing application-base specific classifier model developed for a particular application class. In various aspects, the computing device may be configured to update application groups on a continuous rolling basis (e.g., at regular intervals such as duty cycles) to add new applications to an appropriate application group, without the need for user intervention.

In some aspects, the computing device may be configured to transmit and receive application group metadata and/or application-based classifier models to and from a remote server. The server may be configured as a crowdsourcing repository, in which application group metadata and application-based classifier models are received and stored from numerous computing devices. Application group metadata and application-based classifier models may be grouped within a storage of the remote server by user equipment type (e.g. Apple iPhone0, Samsung Galaxy® Tablet, etc.). In some aspects, the computing device may be configured to receive application group metadata and application-based classifier models transmitted from the remote server, in lieu of generating the application group metadata and the application-based classifier models locally.

The computing device may be configured to use the generated application-based classifier models to perform real-time behavior monitoring and analysis operations. In an aspect, the computing device may be configured to use or apply multiple classifier models in parallel to accommodate applications associated with multiple application groups. In various aspects, the computing device may be configured to give preference or priority to the results generated from using or applying the application-based classifier model to a behavior/feature vector based on a weight assigned to the application's similarity to the application groups with which the application is associated. In various aspects, the computing device may be configured to give preference or priority to the results generated from using or applying a locally or crowd-sourced application-based classifier model to a behavior/feature vector over the results generated from applying a preinstalled or generic application-based classifier model to a behavior/feature vector. In the various aspects, the computing device may use the results of applying the classifier models to predict whether a computing device behavior (i.e., software application feature) is benign or contributing to the degradation of the performance or power consumption characteristics of the computing device.

By dynamically generating and modifying classifier models based on local user preferences regarding computing device behavior permissions, the various aspects allow the computing device to ignore those features that might otherwise be classified as malicious or performance degrading, but which the computing device user has consistently permitted to execute regardless of the risk. Grouping the computing device applications into clusters or classifications may enable the computing device processor to detect patterns in user input regarding execution of behaviors or features presenting a high risk of malicious activity or performance degradation. By ignoring features that the user permits to execute regardless of risk with respect to all applications within a cluster, the computing device may be allowed to focus the device's monitoring and analysis operations on a small number of features to determine whether the operations of a specific software application are contributing to an undesirable or performance depredating behavior of the computing device. This improves the performance and power consumption characteristics of the computing device, and allows the computing device to perform the real-time behavior monitoring and analysis operations continuously or near continuously without consuming an excessive amount of computing device resources (e.g., processing, memory, or energy resources).

In various aspects, the methods and computing devices may calculate application similarity to produce improved customization of behavior classifier models, and thereby reduce the hardware and power resources required to monitor and identify malicious or performance degrading behavior on the computing device.

In an aspect, the network server may generate the full classifier model to include a finite state machine expression or representation, which may be an information structure that includes a boosted decision tree/stump or family of boosted decision trees/stumps that can be quickly and efficiently culled, modified or converted into lean classifier models that are suitable for use or execution in a computing device processor. The finite state machine expression or representation (abbreviated to “finite state machine”) may be an information structure that includes test conditions, state information, state-transition rules, and other similar information. In an aspect, the finite state machine may be an information structure that includes a large or robust family of boosted decision stumps that each evaluate or test a feature, condition, or aspect of a computing device behavior.

The computing device may be configured to receive a full classifier model from the network server, and use the received full classifier model to generate lean classifier models (i.e., data/behavior models) that are specific for the features and functionalities of the computing device.

In various aspects, the computing device may use unsupervised machine learning techniques to form application groups in which each application associated with the group shares common behavior characteristics. Clustering techniques, such as those employing k-means, hierarchical, mix/mixture, mahalanobis distance, distance between API calls, and other clustering algorithms may be used to identify related groupings of applications having common behavior characteristics (i.e., similar behavior vector elements).

In various aspects, the computing device may map application behavior vectors in a dimensional space of order “N” equal to the number of elements (i.e., features) in a behavior vector. Each dimension 1 . . . N may correspond to a feature (i.e., an element of the behavior vector) that is observed and analyzed by the behavior monitoring and classification system. For each application, an associated behavior vector may determine a position within the N-dimensional space. Applications exhibiting similar behaviors or application features may lie closer in position within the N-dimensional space than those applications that do not share common behaviors or application features.

A result of the behavior vector mapping may be the formation of clusters such that a number of applications are distributed within a common region of the N-dimensional space. The computing device may determine the number and scale of these clusters in order to prepare for grouping applications. For example, after the initial mapping of behavior vectors to the N-dimensional space, the computing device may select a number of points or centroids to be used as initial mean estimates. The actual mean of the nearest behavior vector coordinates may be calculated and the centroids adjusted to the new positions. This procedure may continue until the centroids converge/stabilize. Thus a k-means clustering method or other initial clustering algorithm may be utilized to determine clusters of applications within the N-dimensional space.

The center of mass, or “cluster center,” of each cluster may represent a mean or average position within the N-dimensional space. In some aspects, initial estimates of the cluster centers may be determined during the determination of clusters within the N-dimensional space. However, some unsupervised machine learning techniques may not require such initial estimations of the cluster centers. In all embodiments, the mean or average coordinate position of each cluster within the N-dimensional space should be calculated or re-calculated prior to forming application groups, which are the product of assigning one or more applications to the distributions represented by the one or more clusters and respective cluster centers in the N-dimensional space.

In various aspects, the covariance matrix may be calculated for each cluster along with the cluster center, and prior to calculating the distance of a behavior vector from a cluster center. Together, a cluster center and associated covariance matrix (collectively “application group metadata”) may be used to determine one or more application group assignments for a new application being mapped to the N-dimensional space.

A “distance” measurement associated with the proximity of behavior vectors to a mean may or may not be determined in terms of Euclidean geometry. The mahalanobis distance may be used to determine the similarity of a behavior vector to the mean of a cluster (e.g. a cluster center). Such distances may not be Euclidean due to differences associated with feature variance along different axes (i.e., variance associated with certain behavior vector elements may be greater than that of others). In such aspects, the “distance” may be a measure of a coordinate's variance from the mean of the distribution rather than a Euclidean (e.g. physical) distance. However, if all features (i.e., behavior vector elements) have the same variance, then the “distance” may reduce to a standard Euclidean distance. Thus, terms such as distance, proximity, and nearness as used herein, are not limited to a Euclidean distance calculation.

Grouping the applications into one or more application groups may include comparing each application of the computing device to the cluster center of each application cluster to produce a measure of similarity to the application group. The applications may be assigned to one or more groups based on the calculated similarity values. The distance between the coordinate position of any application behavior vector within the N-dimensional space and any cluster center may represent a measure of the similarity of the application behavior vector to application behavior vectors associated with the group. This distance (i.e., the mahalanobis distance) for any given behavior vector υ=[υ₁, υ₂, υ₃, . . . υ_{N}]^{T} may be calculated using the cluster center μ=[μ₁, μ₂, μ₃, . . . μ_{N}]^{T} and a cluster covariance matrix S. The similarity value/distance may thus be represented by the expression:

d(υ)=√(̅υ̅−̅μ̅)̅^̅{̅T̅}̅S̅⁻̅¹̅(̅υ̅−̅μ̅)̅

Once the similarity value associated with a particular application behavior vector and each cluster center has been calculated, the computing device may compare the similarity values to determine the smallest value. The application may then be assigned to (i.e., associated with) a group associated with the cluster center having the smallest similarity value. This comparison and assignment may be repeated for all applications of the computing device until all applications have been assigned to one or more application groups.

In some aspects, the initial mapping of application behavior vectors to the N-dimensional space may commence on the computing device. Generating the cluster centers and covariance matrices on the computing device may result in highly customized application groups that may provide a more accurate representation of application similarities than the representation resulting from a more generalized application group metadata set might produce. However, the initial generation of the application groups may be time and resource intensive, and may temporarily degrade computing device performance. To this end, some aspects may include providing predetermined (i.e., preinstalled) application group cluster centers and associated covariance matrices stored in a local memory of the computing device. In such aspects, a preselected sample of applications known to be associated with an application group may be used to calculate a covariance matrix and a cluster center for each application group. These cluster centers and covariance matrices may be stored in local memory until the computing device is activated by a user and applications are assigned to clusters based on the distance of their behavior vectors form the predetermined cluster centers within the N-dimensional space.

In some aspects, application group metadata (i.e., cluster centers and covariance matrices) may be generated and stored on a remote server, and may be downloaded by a computing device along with any associated classifier models. The application group metadata may be generated in the same manner as discussed with respect to predetermined aspects, but may be stored on a remote server in lieu of a local memory.

In some aspects, application group metadata (i.e., cluster centers and covariance matrices) may be downloaded, along with associated classifier models, from one or more crowdsourcing repositories. The remote server hosting the crowdsourcing repository may receive and store application group metadata from users of many different computing devices. Such metadata may have been generated by a remote computing device during a resource intensive initial application mapping, and may have been subsequently transmitted to the repository. In such aspects, a computing device may contact the remote server with a request for application group metadata relevant to the user's computing device, and may download any stored application group metadata and associated classifier models. Further, such aspects may provide an advantage in accuracy of application similarity representation over aspects including predetermined or generic application group metadata, because cluster centers may be averaged or weighted to produce robust application group metadata.

Using the predetermined or downloaded application group metadata, the computing device may generate application groups without executing an initial application mapping. For each application executable on the computing device, the processor of the computing device may determine a similarity value for each application group. As discussed above, the similarity value may be the distance in N-dimensional space of each application behavior vector from an application group center. The computing device processor may select the smallest distance and assign the application to the corresponding application group. If one or more distances are equal, the computing device processor may select one or all of the application groups for application assignment.

In some aspects, the computing device processor may assign a weight to each distance according to the size of the value. For example, the shortest distance might receive a weight of 0.9, while the farthest distance value may receive a weight of 0.005. In this manner, a weighted average of classifier models may be obtained by applying the weight of each distance to a respective application-based classifier model. Thus, such aspects may provide highly customized behavior monitoring and analysis for each application that is executable on the mobile device. In some aspects, all distances greater than a threshold value may be ignored.

In some aspects, if no conclusive determination of similarity is made (e.g., the application is “far” from all known application groups or “close” to many application groups) then the computing device may choose to assign or apply default classifier models and ignore the behavior vector mapping.

By customizing application-based classifier models in the computing device in which the models are used, the various aspects allow the computing device to accurately identify the specific features that are most important in determining whether a behavior on that specific computing device is benign or contributing to that device degradation in performance. These aspects may also allow the computing device to accurately prioritize the features in the lean classifier models in accordance with their relative importance to classifying behaviors in that specific computing device.

In various aspects, the computing device may be configured to monitor and store user input regarding whitelisting of application behaviors. For example, an attempted execution of a behavior classified as malicious or performance degrading may result in the display of an alert notification requesting permission to proceed with execution. If the user allows the execution of the behavior despite the classification of the behavior as malicious or performance degrading, then the grant of permission may be stored in a whitelist history. A whitelist history for each application executable on the computing device may contain permissions grant records for each element of the application behavior vector.

In various aspects, the computing device may be configured to review the whitelist history of each application associated with an application group. The processor of the computing device may analyze the whitelist history of each behavior vector to determine how the computing device user prefers to execute all application features. For example, the computing device may analyze the whitelist histories of applications associated with an application group associated with wireless transmission of sensor input (e.g., fingerprint readers, pedometers, pulse monitors), and may notice that the user consistently whitelists transmission of pedometer input, but does not allow transmission of fingerprint readings. Thus, the computing device may determine that for the application group associated with the wireless transmission of sensor input, the feature of transmitting pedometer input should not be classified as malicious by an application-based classifier model. Conversely, the features associated with transmitting heart rate monitor input and fingerprint data should remain classified by an application-based classifier model as malicious. Such customization is specific to the application group and may not pertain to other application classes or application types. For example, the transmittal of fingerprint data may be consistently permitted by the user with respect to physical data connections (e.g. USB connections), and may be properly whitelisted with respect to an associated application group.

In various aspects, the computing device may generate and apply full or lean classifier models for each application group to provide application-based classifier models pertinent to specific application classes. The computing device may analyze the whitelist history of all applications within an application group and compare the results against current classifier models to determine whether modification is needed. If a current full or lean classifier model, such as a default full classifier model, results in the improper characterization of features when applied to a behavior vector of an application associated with an application group (e.g., classifying whitelisted behaviors as non-benign), then the classifier model may be modified as discussed above (e.g., a boosted decision stump may be updated) to produce a result that properly classifies the feature as non-malicious when applied to a behavior vector of an application associated with the application group.

The installation of new applications on the computing device may result in the real time generation of a behavior vector and mapping of that vector into the N-dimensional space. Like the cluster generation procedure followed with preexisting application group metadata (i.e., predetermined or downloaded application group metadata), the behavior vector of the new application may have a similarity value calculated (e.g., the mahalanobis distance) with respect to each of the existing application groups, and may be associated with one or more appropriate application groups as discussed above.

In various aspects, updating of application groups may occur on a periodic or continuous basis. Because application features may change over the life of the application and/or the computing device, the behavior vector associated with that application might change. Consequently, the mapping of the behavior vector into the N-dimensional space may result in updated positioning and updated similarity values with respect to each of the application groups. As such, application group generation and modification may occur regularly to ensure that application-based classifier models applied to behavior vectors are current and consistent with application features and user preferences. In some aspects, the generation and updating of application group clusters may occur periodically, such as on duty cycles, or may occur on a continuous basis according to resource consumption constraints on the computing device.

In various aspects, the modification of application-based classifier models may be limited. Initial generation of application-based classifier models may occur at the time of initial application group generation. However, the continued modification of the application-based classifier models may present an unnecessary drain on computing device power and hardware resources, because the application-based classifier models represent user preferences with respect to execution of features of applications within an application group, and thus may not be updated without a change in user preferences. Instances of user input regarding feature execution preferences may present a deviation from prior user preferences and may warrant updating of classifier models for one or more application groups. In this manner, the input of user preferences may trigger the modification of application-based classifier models for a particular class or group of applications.

Thus, the various aspects may provide methods and computing devices for grouping computing device applications based on commonality of behavioral features, and may generate application-based classifier models accordingly. These application-based classifier models for specific application classes may incorporate user preferences for the handling of features that have been classified by a full or lean classifier model as being potentially malicious or performance degrading.

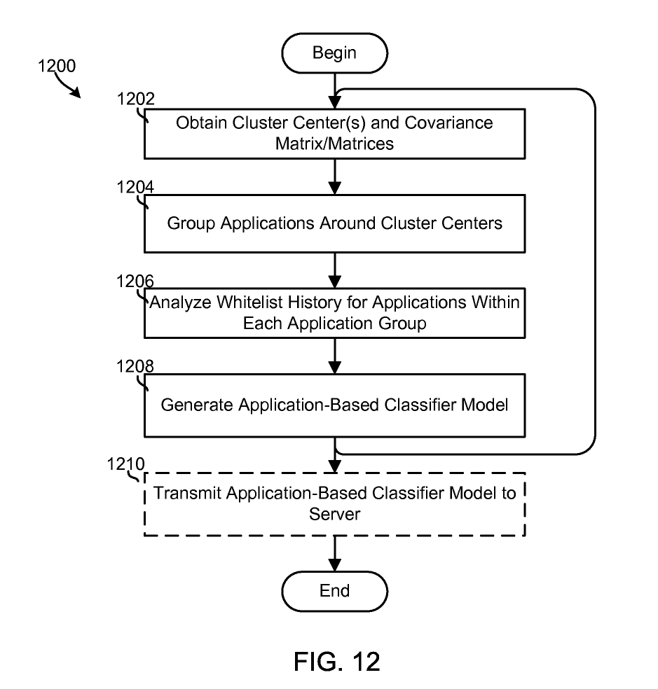

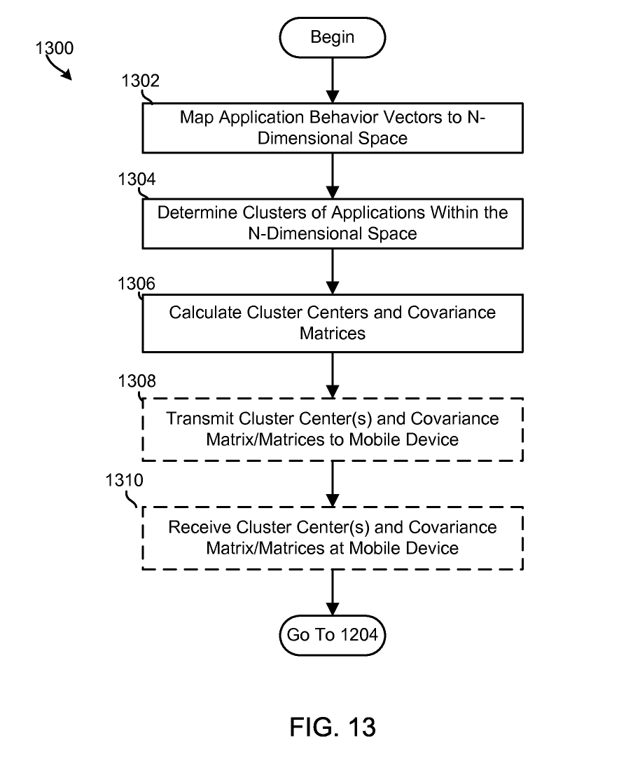

FIG. 12 shows an aspect computing device method 1200 for generating application-based classifier models. In block 1202, the processor of the computing device may obtain one or more pieces of application group metadata (i.e., cluster centers and covariance matrices). The application group metadata may include one or more cluster centers and associated covariance matrices. The cluster centers may represent a position in an N-dimensional space, where the represented position is the center of mass of a sample distribution. The sample distribution may be a distribution of behavior vectors associated with applications executable on the computing device. Alternatively, the sample distribution may be behavior vectors associated with example applications known to be associated with the pertinent application group. The covariance matrices may represent the covariance of samples within each distribution. As will be discussed in greater detail with reference to FIG. 13, the application group metadata may be generated locally on the computing device, preinstalled, or downloaded from a remote server via a network.

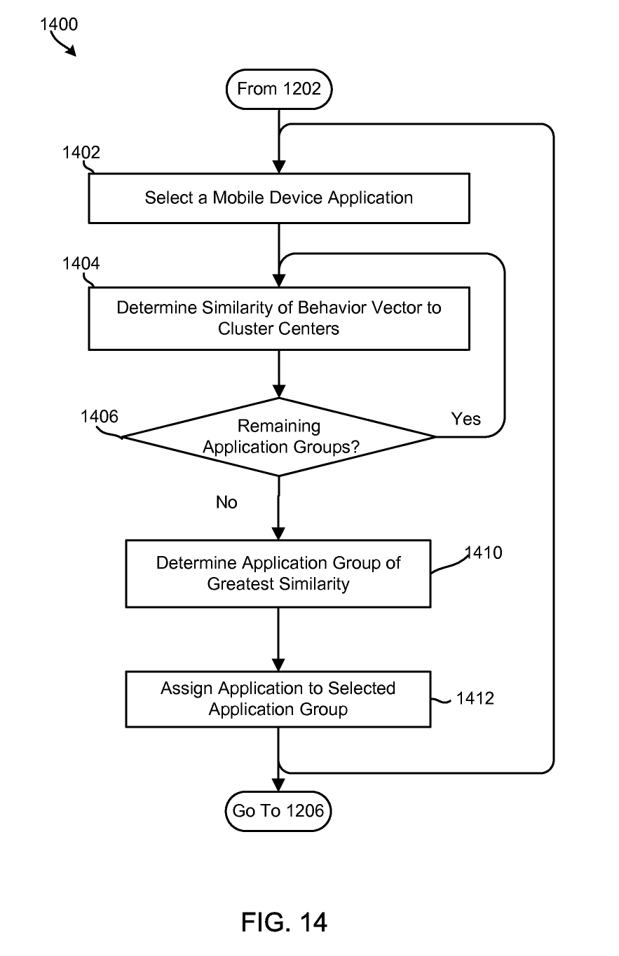

In block 1204, the processor of the computing device may group applications into one or more application groups using the application group metadata (i.e., the cluster centers and the covariance matrices). As will be discussed in greater detail with reference to FIG. 14, applications on the computing device may be assigned to one or more application-based groups based on the similarity of their behavior vector elements to behavior vectors of applications associated with the application group.

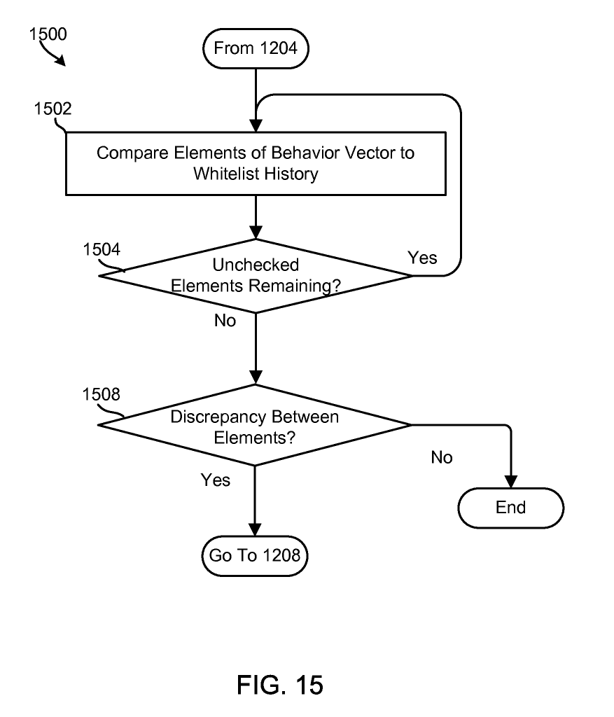

In block 1206, the processor of the computing device may compare a default classifier model to a behavior vector and associated whitelist history (i.e., historical user input) for each application associated with the application group. As will be discussed in greater detail with reference to FIG. 15, the processor of the computing device may analyze user whitelist history to determine whether to generate and/or modify an application-based classifier model for a particular application group.

In block 1208, the processor of the computing device may generate a full or lean application-based classifier model based on the comparison in block 1206, or may modify an existing application-based classifier model to incorporate new user preferences with regard to execution and handling of features pertinent to a respective application group. The manner of generating and/or modifying full and lean classifier models may commence in the manner described above with reference to FIGS. 2-11.

Optionally, the processor of the computing device may transmit the resultant full or lean application-based classifier model(s) along with associated application group metadata to a remote server. In some aspects, the remote server may be a crowdsourcing repository in which application-based classifier models and application group metadata for varied types of computing devices may be aggregated and studied, or made available for download by users of similar computing devices. In this manner, the application-based classifier models and application group metadata may be used by third parties to study user preferences regarding particular computing device features. Further, the aggregation of numerous instances of application-based classifier models for the same application group of the same type of device may result in a robust, averaged model that is highly customized, but may be downloaded and used by users of the relevant type of computing device.

In other words, the aspect method of building classifier models in a computing device, may include obtaining, by a processor of the computing device, a cluster center (e.g., mean, a center point, center of mass, distribution center, etc.) and a covariance matrix, for generating one or more application groups or groupings. The processor may group applications around each cluster center to generate the one or more application groups. Application groups may include applications of shared type, class, theme, or other shared characteristic (e.g., commonly used features, required hardware, preferred usage, etc.). The processor may further compare a default classifier model (e.g., a pre-packaged, pre-installed, or downloaded default model) to a behavior vector and associated whitelist histories for each of the applications. In some aspects each element of a behavior vector may have an associated whitelist history detailing the permissions history of an application feature associated with the element. Thus, the behavior vectors of different applications may have elements that share a common whitelist history because the elements are associated with the same feature (e.g., access to location information or app purchase history). The processor may also generate an application group classifier model (i.e., application-group specific classifier model or application-based classifier model) for each application group based on a result of comparing the default classifier model to the behavior vector and the associated whitelist histories for each of the applications, and may use the application group classifier model in the computing device to classify a behavior of one or more of the applications.

FIG. 13 illustrates an aspect computing device method 1300 for obtaining application group metadata (i.e., cluster centers and covariance matrices) for use in generating application-based classifier models. In block 1302, the behavior vectors of multiple applications may be mapped to an N-dimensional space in which each dimension represents an element of a behavior vector (i.e., a feature being monitored and analyzed by the behavior classification system). In some aspects, the mapping (initial mapping) may commence locally on the computing device, and the applications may be actual applications installed on the computing device. In some aspects, the initial mapping may include a set of example applications known to be associated with a desired application group, and may be preinstalled on the computing device, or may commence on or be stored upon a remote server.

In block 1304, the processor of the computing device generating the application group metadata (e.g., cluster centers and covariance matrices) may determine one or more clusters of applications within the N-dimensional space. The clusters may be representative distributions of applications having behavior vector mappings (i.e. N-space coordinate positions) in proximity to one another.

In block 1306, the computing device generating the application group metadata (i.e., the computing device or remote server) may calculate a covariance matrix and a cluster center for each of the sample distributions. The cluster centers may represent the center of mass or average position for a sample distribution and may be used in conjunction with the covariance matrix to determine a similarity value for an application behavior vector.

Optionally, in block 1308, if the application group metadata was generated on a remote server, the server may transmit the application group metadata. In optional block 1310, the computing device may receive the application group metadata.

FIG. 14 illustrates an aspect computing device method 1400 for generating application groups using application group metadata obtained in block 1202 of FIG. 12, or blocks 1306 or 1310 of FIG. 13. In block 1402, the processor of the computing device may select an application for classification. The application may be one installed on and executable on the computing device. In accordance with the various aspects, the application may have a behavior vector having N-elements characterizing behavioral features of the application. This behavior vector may be mapped to a position in an N-dimensional space to produce a position.

In block 1404, the processor of the computing device may determine the similarity of the behavior vector of the selected application to a cluster center by calculating a similarity value representing the similarity of the behavior vector to behavior vectors associated with the application group. In some aspects, the similarity value may be a mahalanobis distance, calculated using the cluster center and covariance, and representing the distance from the position of the behavior vector mapped in N-dimensional space, to the position of the cluster center. The similarity value calculation may be repeated for each application group.

In block 1406, the processor may determine whether a similarity value has been calculated with respect to all application groups. If there are remaining application groups (i.e., block 1406 evaluates to “Yes”) the processor of the computing device may determine the similarity of the behavior vector of the selected application to a cluster center for a new application group in block 1404.

If all similarity values (e.g., mahalanobis distances) have been calculated with respect to the behavior vector and the application groups (i.e., block 1406 evaluates to “No”), the processor of the computing device may determine the application groups with which the behavior vector is associated. In various aspects, the processor may determine the similarity values that are smallest, and thus represents the shortest distance between the behavior vector position and the position of the cluster center in the N-dimensional space.

In block 1412, the processor of the computing device may assign the application to one or more application groups associated with the greatest correspondence (i.e., the smallest similarity values) to the behavior vector of the selected application based on the similarity values.

FIG. 15 illustrates an aspect computing device method 1500 for analyzing a whitelist history for applications associated with an application group. In block 1502, the processor of the computing device may compare elements of the behavior vectors of applications associated with an application group to historical whitelist records for those elements. In various aspects, the number of elements analyzed per behavior vector may be only one. This is because each dimension of the N-dimensional mapping space correlates to one element (i.e., one feature) index of a behavior vector. Thus, the primary element of interest in a fifth direction (i.e., along a fifth axis) may be behavior vector element s at index position 5. In some aspects, multiple elements may be analyzed due to their correlation to a primary feature. For every element of interest in a behavior vector, the whitelist history with respect to that behavior vector element may be analyzed.

In determination block 1504, the processor of the computing device may determine whether any relevant elements of a behavior vector remain unanalyzed with respect to their whitelist history. If elements remain, (i.e., determination block 1504=“yes”) the processor of the computing device may continue to compare elements of the behavior vectors of applications associated with an application group to historical whitelist records for those elements in block 1502 until all elements are analyzed.

In block 1508, the processor of the computing device may compare the whitelist history of the behavior vector elements to a default classifier model to determine whether are any discrepancies. Discrepancies may result in the classification of behaviors as malicious despite a user's preference for allowing execution of the behaviors. The processor may perform the comparison for each application associated with an application group. In various aspects if more than a threshold number of applications associated with an application group produce discrepancies when their behavior vectors and whitelist history are compared to a default classifier model, then the processor may proceed to block 1208 to generate or modify an application-based classifier model.

In other words, various aspects may include methods and computing devices for building application-based classifier models, such as application-type or application-based classifier models. The computing device may obtain one or more pieces of application group metadata, which may include one or more cluster centers and a covariance matrix for each of the one or more cluster centers. The application group metadata may be generated on the computing device, preinstalled on the computing device, or downloaded from a server, which may be a crowdsourcing repository. The computing device may generate multiple application groups, wherein each of the application groups is centered around one of the one or more cluster centers and comprised of multiple applications, wherein the applications are executable on the computing device. Generating the application groups may include execution of one or more mathematical operations such as k-means clustering, mahalanobis distance clustering, or other similarity distribution type clustering operations. The computing device may also compare behavior vectors and whitelist history of each of the applications associated with one of the application groups to a default classifier model. In some aspects, both the behavior vectors and the default classifier model may be vectors (i.e. arrays, matrices) containing an equal or similar number of elements. The computing device may generate an application-based classifier model based on comparing the behavior vectors and the whitelist history of each of the applications associated with one of the application groups to the default classifier model. A result of the generation of the application-based classifier model may be used by the application-based classifier model in the computing device to classify a behavior of one or more of the applications associated with one of the application groups.

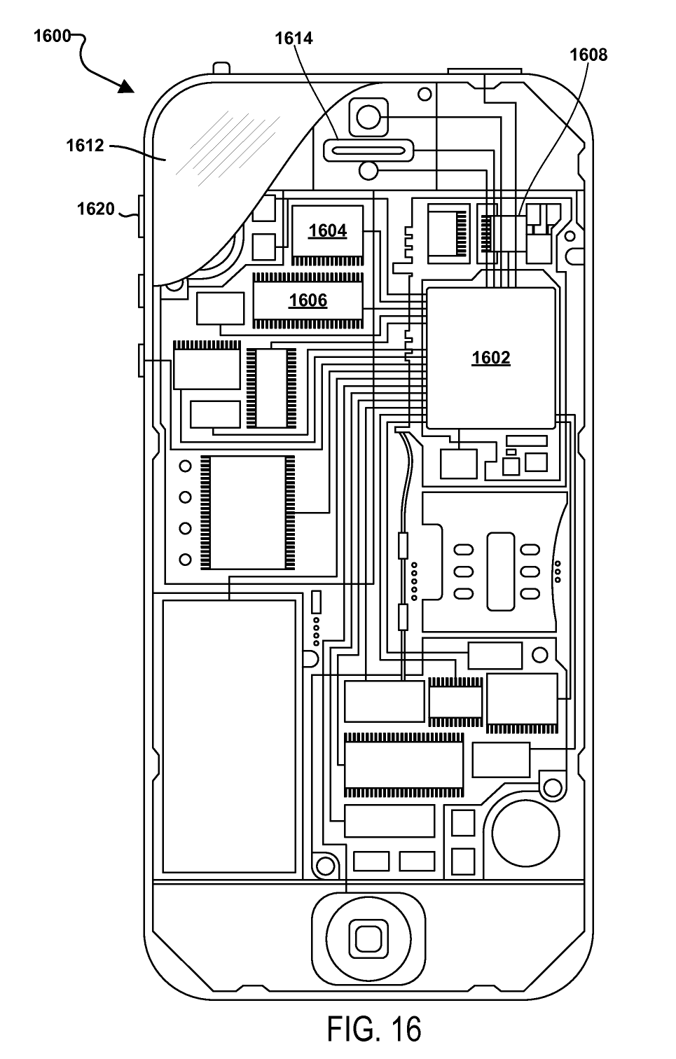

The various aspects may be implemented on a variety of computing devices, an example of which is illustrated in FIG. 16 in the form of a smartphone. A smartphone 1600 may include a processor 1602 coupled to internal memory 1604, a display 1612, and to a speaker 1614. Additionally, the smartphone 1600 may include an antenna for sending and receiving electromagnetic radiation that may be connected to a wireless data link and/or cellular telephone transceiver 1608 coupled to the processor 1602. Smartphones 1600 typically also include menu selection buttons or rocker switches 1620 for receiving user inputs.

A typical smartphone 1600 also includes a sound encoding/decoding (CODEC) circuit 1606, which digitizes sound received from a microphone into data packets suitable for wireless transmission and decodes received sound data packets to generate analog signals that are provided to the speaker to generate sound. Also, one or more of the processor 1602, wireless transceiver 1608 and CODEC 1606 may include a digital signal processor (DSP) circuit (not shown separately).

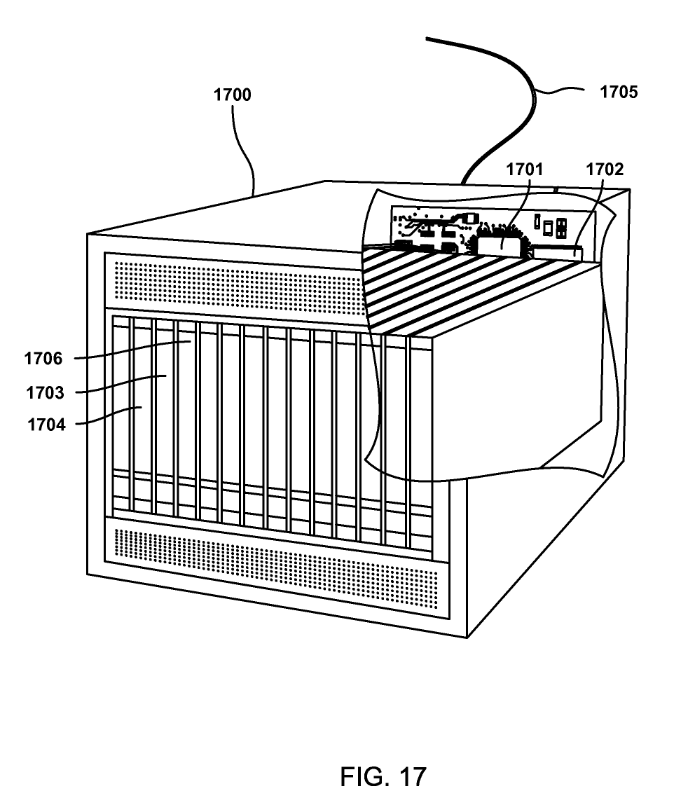

Portions of the aspect methods may be accomplished in a client-server architecture with some of the processing occurring in a server, such as maintaining databases of normal operational behaviors, which may be accessed by a computing device processor while executing the aspect methods. Such aspects may be implemented on any of a variety of commercially available server devices, such as the server 1700 illustrated in FIG. 17. Such a server 1700 typically includes a processor 1701 coupled to volatile memory 1302 and a large capacity nonvolatile memory, such as a disk drive 1703. The server 1700 may also include a floppy disc drive, compact disc (CD) or digital versatile disc (DVD) disc drive 1704 coupled to the processor 1301. The server 1700 may also include network access ports 1706 coupled to the processor 1701 for establishing data connections with a network 1705, such as a local area network coupled to other broadcast system computers and servers.

The processors 1602, 1701 may be any programmable microprocessor, microcomputer or multiple processor chip or chips that can be configured by software instructions (applications) to perform a variety of functions, including the functions of the various aspects described below. In some computing devices, multiple processors 1602 may be provided, such as one processor dedicated to wireless communication functions and one processor dedicated to running other applications. Typically, software applications may be stored in the internal memory 1604, 1702, 1703 before they are accessed and loaded into the processor 1602, 1701. The processor 1602, 1701 may include internal memory sufficient to store the application software instructions.

The term “performance degradation” is used in this application to refer to a wide variety of undesirable computing device operations and characteristics, such as longer processing times, slower real time responsiveness, lower battery life, loss of private data, malicious economic activity (e.g., sending unauthorized premium SMS message), denial of service (DoS), operations relating to commandeering the computing device or utilizing the phone for spying or botnet activities, etc.

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many computing devices operating system kernels are organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples, and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” “engine,” “generator,” “manager,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution, and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

The various illustrative logical blocks, modules, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a multiprocessor, but, in the alternative, the processor may be any conventional processor, controller, microcontroller, or state machine. A processor may also be implemented as a combination of computing devices, e.g., a combination of a DSP and a multiprocessor, a plurality of multiprocessors, one or more multiprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects. Thus, the present disclosure is not intended to be limited to the aspects shown herein but is to be accorded the widest scope consistent with the following claims and the principles and novel features disclosed herein.

What is claimed is:

1. A method of building classifier models in a computing device, comprising:
obtaining, by a processor of the computing device, a cluster center and a covariance matrix for generating one or more application groups;
grouping applications around each cluster center to generate the one or more application groups;
comparing a default classifier model to a behavior vector and associated whitelist histories for each of the applications;
generating an application-based classifier model for each application group based on a result of comparing the default classifier model to the behavior vector and the associated whitelist histories for each of the applications; and
using the application-based classifier model in the computing device to classify a behavior of one or more of the applications.

2. The method of claim 1, wherein obtaining, by the processor of the computing device, the cluster center and the covariance matrix, for generating the one or more application groups, comprises:
mapping the behavior vector of each of the applications to an N-dimensional space;
determining one or more clusters of applications within the N-dimensional space using a clustering algorithm;
calculating the covariance matrix for each of the one or more clusters of applications using the behavior vector of all the applications associated with each of the one or more clusters of applications respectively; and
calculating an average for each of the one or more clusters of applications using the behavior vector of all the applications associated with each of the one or more clusters of applications respectively, wherein the average determines the cluster center.

3. The method of claim 1, wherein obtaining, by the processor of the computing device, the cluster center and the covariance matrix for generating the one or more application groups, comprises:
mapping, by a server, the behavior vector of each of the applications in a set of the applications known to be associated with one of the application groups to an N-dimensional space, wherein the N-dimensional space has one or more clusters of applications;
calculating, by the server, the covariance matrix using the behavior vector of all of the set of the applications known to be associated with one of the application groups;
calculating, by the server, an average of the behavior vector for all of the applications, wherein the average represents the cluster center;
transmitting, by the server, the cluster center and covariance matrix of each of the application groups; and
receiving, by the computing device, cluster centers and covariance matrices of each of the application groups.

4. The method of claim 1, wherein obtaining, by the processor of the computing device, the cluster center and the covariance matrix for generating the one or more application groups comprises:
selecting, by a server, the cluster center and covariance matrix of one or more application groups;
transmitting, by the server, the cluster center and covariance matrix of the one or more application groups; and
receiving, by the computing device, the cluster center and covariance matrix of the one or more application groups.

5. The method of claim 1, wherein grouping the applications around each cluster center to generate the one or more application groups comprises:
selecting the applications;
determining the application groups with which each of the applications is associated; and
assigning each of the applications to one or more of the application groups.

6. The method of claim 5, wherein determining the application groups with which each of the applications is associated, comprises:
calculating a similarity value for each of the applications with reference to each of the application groups, wherein the similarity value represents a similarity of the behavior vector of each of the applications to the cluster center of one of the application groups;
determining the smallest similarity value for each of the applications; and
selecting, for each of the applications, one of the application groups based on the smallest similarity value.

7. The method of claim 6, wherein the similarity value is a mahalanobis distance.

8. The method of claim 1, comparing the default classifier model to the behavior vector and the associated whitelist histories for each of the applications, comprises;
comparing each element of the behavior vector of each of the applications to the associated whitelist histories and to a corresponding element of the default classifier model; and
determining, based on the result of comparing each element of the behavior vector of each of the applications to the associated whitelist histories, whether the behavior vector represents a different behavior classification than a behavior classification represented by the default classifier model.

9. The method of claim 8, wherein the associated whitelist histories are records of user inputs regarding feature permissions.

10. The method of claim 8, wherein determining, based on the result of comparing each element of the behavior vector of each of the applications to the associated whitelist histories, whether the behavior vector represents the different behavior classification than the behavior classification represented by the default classifier model comprises:
determining whether a threshold number of behavior vectors are different from the default classifier model.

11. The method of claim 1, further comprising:
sending the cluster center and the covariance matrix of the one or more application groups and the application-based classifier model from the computing device to a server; and
storing, by the server, the cluster center and the covariance matrix of the one or more application groups and the application-based classifier model in a crowdsourcing repository.

12. The method of claim 1, further comprising:
receiving input from a user regarding whitelist permissions for a feature of the applications; and
updating one of the associated whitelist histories of a behavior vector element corresponding to the feature of the applications.

13. The method of claim 1, further comprising generating the application groups, at regular intervals.

14. A computing device comprising:
a memory; and
a processor coupled to the memory and configured with processor-executable instructions to perform operations comprising:
obtaining a cluster center and a covariance matrix, for generating one or more application groups;
grouping applications around each cluster center to generate the one or more application groups;
comparing a default classifier model to a behavior vector and associated whitelist histories for each of the applications;
generating an application-based classifier model for each application group based on a result of comparing the default classifier model to the behavior vector and the associated whitelist histories for each of the applications; and
using the application-based classifier model in the computing device to classify a behavior of one or more of the applications.

15. The computing device of claim 14, wherein the processor is further configured with processor-executable instructions to perform operations such that obtaining a cluster center and a covariance matrix, for generating one or more application groups comprises:
mapping the behavior vector of each of the applications to an N-dimensional space;
determining one or more clusters of applications within the N-dimensional space using a clustering algorithm;
calculating the covariance matrix for each of the one or more clusters of applications using the behavior vector of all the applications associated with each of the one or more clusters of applications respectively; and
calculating an average for each of the one or more clusters of applications using the behavior vector of all the applications associated with each of the one or more clusters of applications respectively, wherein the average determines the cluster center.

16. The computing device of claim 14, wherein the processor is further configured with processor-executable instructions to perform operations such that grouping applications around each cluster center to generate the one or more application groups comprises:
selecting the applications;
determining the application groups with which each of the applications is associated; and
assigning each of the applications to one or more of the application groups.

17. The computing device of claim 16, wherein the processor is further configured with processor-executable instructions to perform operations such that determining with which of the application groups each of the applications is associated comprises:
calculating a similarity value for each of the applications with reference to each of the application groups, wherein the similarity value represents a similarity of the behavior vector of each of the applications to the cluster center of one of the application groups;
determining the smallest similarity value for each of the applications; and
selecting, for each of the applications, one of the application groups based on the smallest similarity value.

18. The computing device of claim 14, wherein the processor is further configured with processor-executable instructions to perform operations such that comparing a default classifier model to a behavior vector and associated whitelist histories for each of the applications comprises:
comparing each element of the behavior vector of each of the applications to the associated whitelist histories and to a corresponding element of the default classifier model; and
determining, based on the result of comparing each element of the behavior vector of each of the applications to the associated whitelist histories, whether the behavior vector represents a different behavior classification than a behavior classification represented by the default classifier model.

19. The computing device of claim 18, wherein the processor is further configured with processor-executable instructions to perform operations such that determining, based on the result of comparing each element of the behavior vector of each of the applications to the associated whitelist histories, whether the behavior vector represents a different behavior classification than the behavior classification represented by the default classifier model comprises:
determining whether a threshold number of behavior vectors are different from the default classifier model.

20. A non-transitory processor-readable medium having stored thereon processor-executable software instructions to cause a processor of a computing device to perform operations comprising
obtaining a cluster center and a covariance matrix, for generating one or more application groups;
grouping applications around each cluster center to generate the one or more application groups;
comparing a default classifier model to a behavior vector and associated whitelist histories for each of the applications;
generating an application-based classifier model for each application group based on a result of comparing the default classifier model to the behavior vector and the associated whitelist histories for each of the applications; and
using the application-based classifier model in the computing device to classify a behavior of one or more of the applications.
